(19) United States
(12) Patent Application Publication
(10) Pub. No.: US 2008/0037382 A1
(43) Pub. Date: Feb. 14, 2008

(54) Optical Recording Medium Having a Control Layer

(75) Inventor: Fumiaki Ueno, Kyoto-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: MATSUSHITA ELECTRIC INDUSTRIAL CO., LTD., Osaka (JP)

(21) Appl. No.: 11/835,072

(22) Filed: Aug. 7, 2007

Related U.S. Application Data
(62) Division of application No. 10/145,156, filed on May 14, 2002.

(30) Foreign Application Priority Data
May 14, 2001 (JP) 2001-142788

(51) Int. Cl. G11B 7/095

(52) U.S. Cl. 369/44.13

(57) ABSTRACT

An optical recording medium is disclosed. The optical recording medium includes an optical disk substrate. A control layer is formed on the optical disk substrate. The control layer includes a control track provided with a tracking control signal. A photosensitive material is formed on the control layer capable of forming a recording track as a result of a change in an optical property of the photosensitive material that is responsive to a specific light beam radiation. The optical property of all the recording tracks on a predetermined circumference of the optical disk substrate is entirely changed in advance.

### CROSS-REFERENCE TO RELATED APPLICATIONS

This application is a divisional of co-pending U.S. application Ser. No. 10/145,156 filed May 14, 2002, the contents of which are incorporated herein by reference in their entirety.

### BACKGROUND OF THE INVENTION

The present invention relates to an optical recording medium, an optical pickup apparatus and a control apparatus for an optical recording medium.

With improvement in performance, recent computers frequently handle a large amount of information such as image data. This situation has caused demands for recording media and recording apparatuses having a large recording capacity. For the purpose of capacity enhancement in recording media, recording media having two or more recording layers have been developed and are commercially available. In the case of DVDs, the reflective coating of the incident-side recording layer is composed of a semitransparent film having a reflectivity of approximately 36%, while the second recording layer is composed of a totally reflective film, whereby the amounts of light reflected from these two recording layers are made substantially equal to each other; this permits two-layer recording. Nevertheless, by superposing further semitransparent layers to make into multilayer structure, a problem occurs that the amount of light reflected from each recording layer decreases with increasing total number of the recording layers. Further, in order to make the amount of light reflected from each recording layer to be substantially equal to each other, the reflectivity of each layer needs to be made accurately. That is, there is the problem that the required accuracy in reflectivity rises with increasing total number of the recording layers.

In order to resolve such problems and achieve capacity enhancement by means of multilayer recording, a medium has been proposed in which recording is carried out in a volume of photosensitive material by means of a change in refractive index (Japanese Laid-Open Patent Publication No. Hei 6-28672). In this recording medium, used is a three-axis stage movable in X, Y and Z directions or a combination of a beam scanner in X and Y directions and a Z stage, whereby data is recorded by changing the refractive index at each point in three dimensions and then reproduced by detecting the change of refractive index at each point.

In the use of removable optical recording media in wide variety of applications, required are the changeability, portability and compatibility of recording media. Nevertheless, in the prior art recording media, each three-dimensional position is identified by a stage and/or a beam scanner, whereby when a medium is removed once, the same position is difficult to be specified again; this has caused a difficulty in the changeability and compatibility of recording media.

In order to resolve the above-mentioned problems, an object of the present invention is to provide: a recording medium having a large capacity and the changeability and compatibility of media; an optical pickup apparatus for the same; and a control apparatus for the same.

Another object of the present invention is to provide a control apparatus for an optical recording medium for recording and/or reproducing a signal at a high speed.

### SUMMARY OF THE INVENTION

In order to resolve the above-mentioned problems, an aspect of the present invention is an optical recording medium comprising a superposition of: a control layer provided with a tracking control signal formed in advance; and a photosensitive material; wherein regions (recording track) provided with a distribution of discrete portions each having an optical property changed correspondingly to data to be recorded within the volume of the photosensitive material are superposed in layered structure on a path (control track) along which a light beam guided on the basis of the tracking control signal in the control layer goes.

The present invention provides a recording medium having a large capacity in which the changeability and compatibility of media is ensured, and in which data is arranged in three dimensions. The control layer is tracked, whereby a signal is recorded into or reproduced from a recording layer formed in layered structure along the tracking control signal.

The photosensitive material is irradiated with a light beam, whereby the refractive index or the like of the photosensitive material is changed. When a photosensitive material having anisotropy is irradiated with a light beam, birefringence occurs in the photosensitive material, and the plane of polarization changes. When the refractive index (expressed as a complex tensor; its real part indicates a refractive index (an ordinary refractive index), while its imaginary part indicates an absorption coefficient) changes, a change is detected in reflection, absorption, transmission, or polarization.

The photosensitive material may be a material (such as a photographic emulsion film) having linearity with respect to light intensity or a material having nonlinearity.

Preferably, the photosensitive material has prominent nonlinearity with respect to light intensity. This “prominent nonlinearity with respect to light intensity” indicates that the property of photosensitive material varies proportional to square or the higher order of incident light intensity. Typically, the electronic polarization P of the substance in the photosensitive material has electric susceptibility of second order or the higher order with respect to the electric field vector E of the light.
P=P(0)+ε₀(χ(1)·E+χ(2)·E²+χ(3)·E³+ . . . )

Here, ε₀ indicates the permittivity of vacuum, while χ indicates electric susceptibility.

More specifically, such nonlinear optical effects of second order include electro-optic effect of first order, SHG (which generates second harmonic) and the like. Nonlinear optical effects of third order include electro-optic effect of second order, THG (which generates third harmonic), optical bistability, two-photon absorption and the like.

The tracking control signal is a reproduction signal obtained, for example, from grooves, inter-groove sections, both of these, wobble pits, or the like formed on the substrate of the optical recording medium.

The “data to be recorded” include layer information, position information, user-recorded information and contents information.

The “path along which a light beam guided on the basis of the tracking control signal in the control layer goes” indicates a path along the longitudinal directions of grooves, inter-groove sections, or both of these, in case that the tracking control signal is a reproduction signal obtained from grooves, inter-groove sections, or both of these formed on the substrate of the optical recording medium. In case that the tracking control signal is obtained from pairs of wobble pits formed discretely on the substrate of the optical recording medium, the “path” indicates a path along which a light beam goes when the light beam is guided such that the amounts of light reflected from pairs of wobble pits are equalized.

The “layered structure” indicates that a plurality of recording layers are formed in parallel to the control layer at diverse elevations from the control layer.

Another aspect of the present invention is an optical recording medium wherein a signal for identifying a layer is recorded in each layer.

The present invention provides an optical recording medium permitting a light beam to access the target position rapidly and accurately.

Even when an optical recording medium according to the present invention is removed from and again mounted on a recording and reproducing apparatus, or alternatively even when the optical recording medium is mounted on another recording and reproducing apparatus, tracking control is carried out again, whereby a recording layer is identified on the basis of the recording layer identification signal; this permits easy identification of the same position in the optical recording medium, and realizes the changeability and compatibility of optical recording media.

Another aspect of the present invention is an optical recording medium wherein a signal for identifying a layer is recorded at a position having a predetermined relation to the recording position of a signal formed in the control layer. The present invention provides an optical recording medium in which the identification signal of each recording layer is easily read out on the basis of a signal formed in the control layer (such as a clock pit signal serving as reference pulses formed in a servo region).

Another aspect of the present invention is an optical recording medium wherein each recording layer is irradiated with light through the control layer, whereby a signal is recorded or reproduced. In the optical recording medium according to the present invention, light returned from the light focused on the control layer is not affected by a recording layer in which the optical property of the photosensitive material has been changed; accordingly, the light returned from the control layer is obtained at a stable level. Thus, focus control, tracking control and the like are carried out stably on the basis of the light returned from the control layer.

Another aspect of the present invention is an optical recording medium wherein on the recording tracks of all the recording layers superposed on the control track in a predetermined region, the optical property of the photosensitive material is changed entirely.

In the optical recording medium according to the present invention, for example, in change reproduction (or alternatively, additional recording after changing), the imaging position of the light beam is changed in the predetermined region; then, returned light from the light beam is detected, whereby the position of the formation of a recording layer is detected accurately; this permits calibration of the position of imaging of the optical pickup apparatus.

Another aspect of the present invention is an optical recording medium wherein non-rewritable intrinsic information is recorded on the control track. Even a malicious user cannot rewrite the intrinsic information (such as information for copy protection) (this protects falsification); further, the intrinsic information can not be read out with an ordinary recording and reproducing apparatus.

Another aspect of the present invention is an optical recording medium wherein a pair of wobble signals are recorded at positions which are different in the longitudinal directions of the recording track of each recording layer and which are displaced oppositely in the thickness directions of the recording layer.

A control apparatus for recording or reproducing a signal into or from the optical recording medium according to the present invention can accurately control the elevation of the imaging point (position in the thickness directions of the photosensitive material) of the light beam; this ensures changeability with precision.

Another aspect of the present invention is an optical recording medium wherein: a pair of wobble signals are recorded at positions which are different in the longitudinal directions of the recording track of each recording layer and which are displaced oppositely in the thickness directions of the recording layer; and another pair of wobble signals are recorded at positions which are different in the longitudinal directions of the recording track of each recording layer and which are displaced in the left and right directions.

A control apparatus for recording or reproducing a signal into or from the optical recording medium according to the present invention ensures changeability with precision by means of the wobble signals, and thereby records or reproduces a signal into or from a recording layer.

Another aspect of the present invention is an optical recording medium, whose clamp section for clamping the optical recording medium onto a control apparatus or whose front and back surfaces are formed with material having a hardness higher than that of the photosensitive material. This improves durability (such as scratch resistance, distortion resistance and wear resistance) of the optical recording medium comprising soft photosensitive material.

Another aspect of the present invention is an optical pickup apparatus which focuses images simultaneously at a first imaging point and a second imaging point which are two different points on the same optical axis, the optical pickup apparatus comprising a first focus adjustment section and a second focus adjustment section, wherein: when the first focus adjustment section is adjusted, two imaging points move; and when the second focus adjustment section is adjusted, the second imaging point moves solely.

Another aspect of the present invention is an optical pickup apparatus which focuses images simultaneously at a first imaging point and a second imaging point which are two different points on the same optical axis, wherein: focus control and tracking control are carried out on the basis of light returned from the first imaging point; and recording or reproduction is carried out by light focused on the second imaging point.

When an optical pickup apparatus according to the present invention records or reproduces a signal into or from the optical recording medium according to the present invention, the changeability and compatibility of media is ensured, whereby a signal is recorded into or reproduced from the recording medium in three dimensions.

Another aspect of the present invention is an optical pickup apparatus used for an optical recording medium comprising a superposition of: a control layer provided with a tracking control signal formed in advance; and a photosensitive material having a variable optical property; the optical pickup apparatus comprising a first laser having a first wavelength and a second laser having a second wavelength shorter than that of the first wavelength, wherein: the first laser reproduces the tracking control signal from the control layer; and the second laser focuses an image in the photosensitive material and thereby records or reproduces a signal.

In the optical pickup apparatus according to the present invention, the returned light from the control layer is easily distinguished from the returned light from the photosensitive material; further, the laser light having the shorter wavelength is used in recording or reproducing, whereby recording of a signal is carried out in the optical recording medium at a high recording density.

Another aspect of the present invention is an optical pickup apparatus used for an optical recording medium comprising a superposition of: a control layer provided with a tracking control signal formed in advance; and a photosensitive material having a variable optical property; the optical pickup apparatus comprising a first laser, a second laser, a third laser and a fourth laser, wherein: the first laser reproduces the tracking control signal from the control track provided in the control layer; the second laser records at least a signal selected from the group consisting of a clock signal, a position information signal, a recording layer identification signal and a data signal, onto the recording track of each recording layer; the third laser records a first wobble signal at a position displaced from the recording track of each recording layer into a thickness direction of the recording layer; and the fourth laser records a second wobble signal at a position displaced from the recording track of each recording layer into the direction opposite to the first wobble signal.

Another aspect of the present invention is an optical pickup apparatus comprising a second laser, a third laser and a fourth laser, wherein: the second laser records at least a signal selected from the group consisting of a clock signal, a position information signal, a recording layer identification signal and a data signal, into each recording layer, and at the same time, reproduces a tracking control signal from the control layer; the third laser records a first wobble signal at a position displaced from the recording track of each recording layer into a thickness direction of the recording layer; and the fourth laser records a second wobble signal at a position displaced in the direction opposite to the first wobble signal.

In a recording apparatus comprising the optical pickup apparatus according to the present invention, wobble signals are accurately recorded by means of returned light from the control layer, whereby an optical recording medium according to the present invention is fabricated.

A control apparatus, on which an optical recording medium provided with wobble signals recorded by the optical pickup apparatus according to the present invention (which is installed, for example, in a control apparatus for an optical recording medium used in a factory of optical recording media) is mounted, can carry out accurate focus control of the light beam in recording or reproduction.

Another aspect of the present invention is an optical pickup apparatus further comprising, in addition to the above-mentioned components, a fifth laser and a sixth laser, wherein: the fifth laser records a third wobble signal at a position displaced from the longitudinal directions of the recording track in each recording layer into either left or right direction; and the sixth laser records a fourth wobble signal at a position displaced in the direction opposite to the third wobble signal.

In a recording apparatus comprising the optical pickup apparatus according to the present invention, wobble signals are accurately recorded by means of returned light from the control layer, whereby an optical recording medium according to the invention is fabricated.

A control apparatus, on which an optical recording medium provided with wobble signals recorded by the optical pickup apparatus according to the invention (which is installed, for example, in a control apparatus for an optical recording medium used in a factory of optical recording media) is mounted, can carry out accurate focus control and tracking control of the light beam in recording or reproduction.

Another aspect of the present invention is an optical pickup apparatus which, in recording or reproduction of an optical recording medium having a control layer and a photosensitive material thereon, carries out focus control on the basis of reproduced signals from a pair of wobble signals recorded above and below a recording track.

The optical pickup apparatus according to the present invention can carry out accurate focus control of the light beam in recording or reproduction.

This provides an optical pickup apparatus in which the changeability and compatibility of media is ensured, and in which a signal is recorded into or reproduced from a recording medium.

Another aspect of the present invention is an optical pickup apparatus which, in recording or reproduction of an optical recording medium provided with two pairs of wobble signals above and below and in the left and right of a recording track, carries out focus control on the basis of a pair of wobble signals recorded at positions displaced in the directions opposite to each other in the thickness directions of the recording layer of an optical recording medium, and which carries out tracking control on the basis of another pair of wobble signals recorded at positions displaced from the recording track within each recording layer into the left and right directions.

The optical pickup apparatus according to the present invention can carry out accurate focus control of the light beam in recording or reproduction. This provides an optical pickup apparatus in which the changeability and compatibility of media is ensured, and in which a signal is recorded into or reproduced from a recording medium.

Another aspect of the present invention is a control apparatus for an optical recording medium, wherein in recording into or reproducing from a recording medium according to the present invention, the distance between two imaging points is changed discretely in equal spacing in the optical axis directions, whereby recording or reproduction of a signal is carried out.

By virtue of this, recording tracks (recording layers) are formed in equal spacing in the elevation directions in the photosensitive material (in the thickness directions of the photosensitive material). Preferably, the control layer is used as the reference level in the elevation direction, whereby the recording tracks are formed in equal spacing.

The scope of a control apparatus includes a recording apparatus, a reproducing apparatus, and a recording and reproducing apparatus.

Another aspect of the present invention is a control apparatus for an optical recording medium having a predetermined region used for detecting the elevation of a recording track, wherein: in the predetermined region, the focal position of a light beam is changed from the control layer to each recording layer; the position (elevation from the control layer) of the recording track of each recording layer relative to the position of the control layer is stored; and the focal position of the light beam is set on the basis of the stored position information of each recording track, whereby recording or reproduction is carried out.

By virtue of this, the changeability and compatibility of media is ensured, whereby a signal is recorded into or reproduced from a recording medium.

Another aspect of the present invention is a control apparatus for an optical recording medium, wherein no signal can be newly recorded in the photosensitive material in a predetermined region in which at least a signal selected from the group consisting of a recording layer identification signal, a wobble signal and a position information signal has been recorded.

This prevents deletion and rewriting of: information necessary for ensuring the changeability and compatibility of media; and information provided in media according to a standard. This provides a control apparatus for recording signal into or reproducing signal from an optical recording medium, ensuring the changeability and compatibility of media.

Another aspect of the present invention is a control apparatus for an optical recording medium in which recording tracks are formed in layered structure within the volume of a photosensitive material, wherein: the control apparatus comprises an optical pickup apparatus which focuses images simultaneously at a first imaging point and a second imaging point which are two different points on the same optical axis; and each of the first and second imaging points is positioned onto the recording track of a different layer to each other, whereby recording or reproduction is carried out on each recording track.

This permits substantial doubling of the recording data rate and the reproduction data rate of the control apparatus for an optical recording medium.

Preferably, the control apparatus for an optical recording medium can record in a recording track and reproduce in another recording track, simultaneously.

The scope of the present invention includes a control apparatus for an optical recording medium, wherein the apparatus comprises an optical pickup apparatus which focuses images at three or more different points on the same optical axis, whereby a signal is recorded into or reproduced from three or more recording tracks.

Although the novel features of the invention are defined in the attached claims, the configuration and subject matter of the invention, together with other objects and features, will be understood and appreciated better when the following detailed description is read with reference to the attached drawings.

### BRIEF DESCRIPTION OF THE DRAWINGS

FIG. 1(a) is a schematic general configuration diagram of an optical recording medium according to Embodiment 1 of the present invention; FIG. 1(b) is a schematic enlarged view of a segment of a control track thereof; and FIG. 1(c) is a schematic enlarged view of a segment of a recording track thereof.

FIG. 2 is a schematic cross sectional view of an optical recording medium according to Embodiment 1 of the present invention.

FIG. 3 is a schematic configuration diagram of an optical pickup apparatus according to Embodiment 1 of the present invention.

FIG. 4 is a configuration diagram of the distributed address format of an optical pickup apparatus according to Embodiment of the present invention.

FIG. 5 is a block diagram of a control apparatus for an optical recording medium according to Embodiment 1 of the present invention.

FIG. 6 is a schematic cross sectional view of an optical recording medium according to Embodiment 2 of the present invention.

FIG. 7 is a schematic cross sectional view of an optical recording medium according to Embodiment 3 of the present invention.

FIG. 8(a) is a schematic general configuration diagram of an optical recording medium according to Embodiment 4 of the present invention; FIG. 8(b) is a schematic enlarged view of a segment of a control track; and FIG. 8(c) is a schematic enlarged view of a segment of a recording track.

FIG. 9 is a schematic cross sectional view of an optical recording medium according to Embodiment 4 of the present invention.

FIG. 10 is a schematic configuration diagram of an optical pickup apparatus according to Embodiment 4 of the present invention.

FIG. 11 is a schematic configuration diagram of an optical pickup apparatus according to Embodiment 5 of the present invention.

FIG. 12 is a schematic configuration diagram of an optical pickup apparatus according to Embodiment 6 of the present invention.

FIG. 13(a) is a schematic general configuration diagram of an optical recording medium according to Embodiment 7 of the present invention; FIG. 13(b) is a schematic enlarged plan view of a servo region of a segment of a recording track thereof; and FIG. 13(c) is a schematic cross sectional view thereof.

FIG. 14 is a chart showing a flow from the fabrication of an optical recording medium to the use of the optical recording medium by a user.

FIG. 15 is a schematic configuration diagram of an optical pickup apparatus according to Embodiment 7 of the present invention.

FIG. 16 is a schematic configuration diagram of a control apparatus for an optical recording medium according to Embodiment 7 of the present invention.

FIG. 17 is a schematic configuration diagram of a second focus adjustment section of a control apparatus for an optical recording medium according to Embodiment 7 of the present invention.

FIG. 18(a) is a schematic general configuration diagram of an optical disk according to Embodiment 8 of the present invention; FIG. 18(b) is a schematic enlarged plan view of a servo region of a segment of a recording track thereof, and FIG. 18(c) is a schematic cross sectional view thereof.

FIG. 19 is a schematic configuration diagram of an optical pickup apparatus according to Embodiment 9 of the present invention.

FIG. 20(a) is a schematic general configuration diagram of an optical recording medium according to Embodiment 10 of the present invention; FIG. 20(b) is a schematic enlarged plan view of a servo region of a segment of a recording track thereof, and FIG. 20(c) is a schematic cross sectional view thereof.

FIG. 21 is a schematic configuration diagram of an optical pickup apparatus according to Embodiment 10 of the present invention.

FIG. 22 is a schematic configuration diagram of a control apparatus for an optical recording medium according to Embodiment 10 of the present invention.

FIG. 23 is a schematic configuration diagram of a second focus adjustment section of a control apparatus for an optical recording medium according to Embodiment 10 of the present invention.

FIG. 24(a) is a schematic general configuration diagram of an optical recording medium according to Embodiment 11 of the present invention; FIG. 24(b) is a schematic enlarged plan view of a servo region of a segment of a recording track thereof; and FIG. 24(c) is a schematic cross sectional view thereof.

FIG. 25 is a schematic configuration diagram of an optical pickup apparatus according to Embodiment 12 of the present invention.

FIG. 26 is a schematic configuration diagram of an optical pickup apparatus according to Embodiment 13 of the present invention.

FIG. 27 is a schematic configuration diagram of a control apparatus for an optical recording medium according to Embodiment 13 of the present invention.

FIG. 28(a) is a schematic general configuration diagram of an optical recording medium according to Embodiment 14 of the present invention; FIG. 24(b) is a schematic cross sectional view thereof; FIG. 28(c) is a cross sectional view of another optical recording medium according to the present invention; and FIG. 28(d) is a cross sectional view of further another optical recording medium according to the present invention.

All or part of the drawings are depicted merely schematically for the purpose of illustration; thus, it should be noted that the relative size and position of the depicted components are not necessarily exact.

### DETAILED DESCRIPTION OF THE INVENTION

The best mode of the invention is described below on the basis of the embodiments with reference to the drawings.

### Embodiment 1

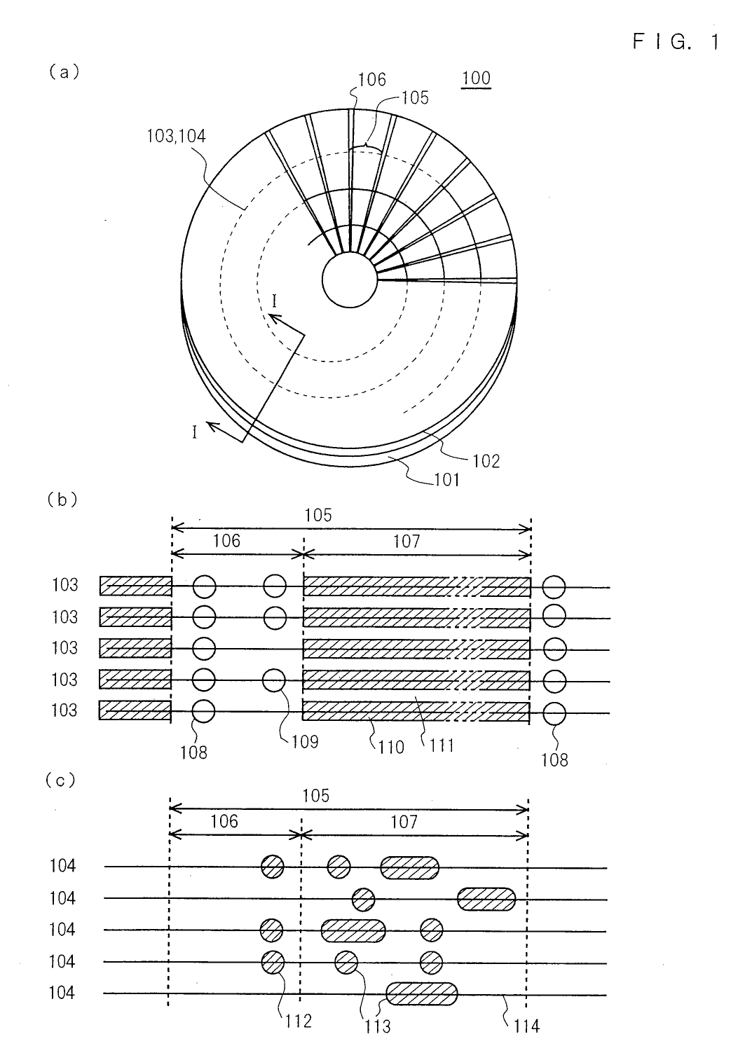

An optical recording medium, an optical pickup apparatus and a control apparatus for an optical recording medium according to Embodiment 1 of the invention are described below with reference to FIGS. 1-5.

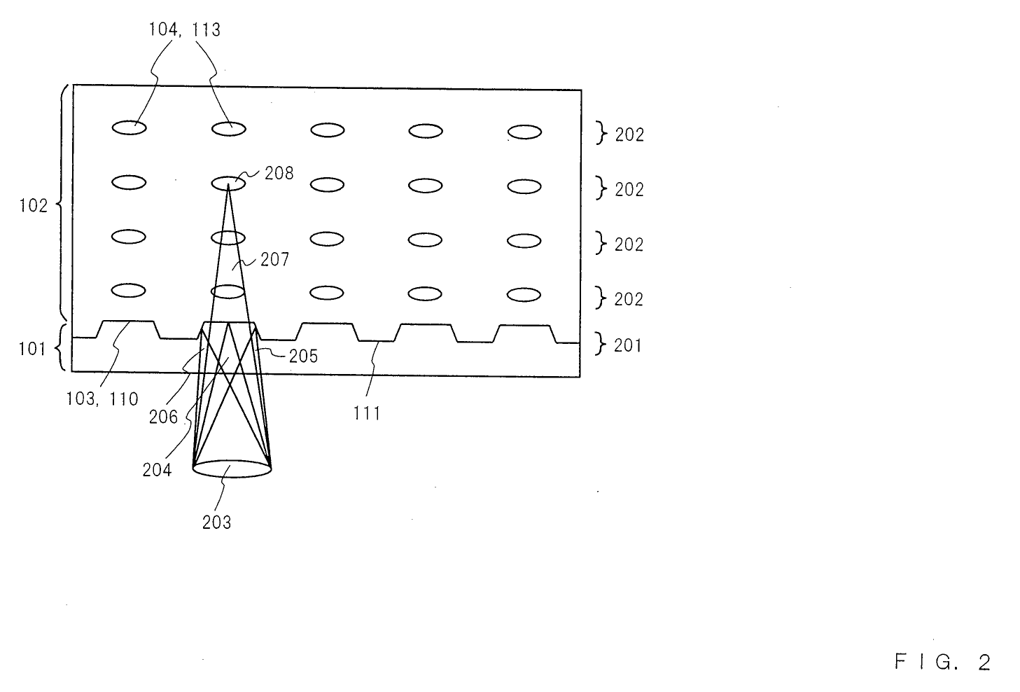

The structure of an optical recording medium according to Embodiment 1 is described below with reference to FIGS. 1 and 2. The optical recording medium according to Embodiment 1 is an optical disk for recording information in three dimensions in a photosensitive material.

In Embodiment 1, the photosensitive material is a photorefractive crystal (such as LiNbO₃, BaTiO₃ and LiIO₃) having prominent nonlinearity with respect to light intensity. In place of this, the photosensitive material may be a resin containing photochromic molecules (such as spirobenzopyran) distributed therein, a photopolymer, a bichromate gelatin, a photographic emulsion film or the like.

When the photorefractive crystal is irradiated with strong light, the refractive index of the irradiated portion changes and remains in the changed state. When the light is focused on a point, the refractive index changes solely at the focus point, whereby a signal is recorded. In the photopolymer, light is focused and thereby records a signal; then, natural light is irradiated uniformly, whereby the refractive index distribution is fixed. In the bichromate gelatin and the photographic emulsion film, light is focused and thereby records a signal; then, development process is carried out, whereby the refractive index distribution is fixed. Also in these materials, when irradiated with strong light, the refractive index of the irradiated portion changes and remains in the changed state; this permits the recording of a signal.

The photochromic molecule, the photopolymer and the like are photosensitive materials having nonlinearity and capable of two-photon absorption.

The two-photon absorption is a phenomenon that a molecule absorbs two photons at once and thereby is excited. The transition probability of one-photon absorption is proportional to the light intensity itself, whereas the transition probability of two-photon absorption is proportional to the square of the light intensity. Thus, when laser light is focused, the transition probability of one-photon absorption is inversely proportional to the square of the distance from the focus, whereas the transition probability of two-photon absorption is inversely proportional to the biquadrate of the distance from the focus. Accordingly, using the phenomenon of two-photon absorption, very high spatial resolution is obtained exceeding the diffraction limit of the recording light. The two-photon absorption occurs at light intensity reaching or exceeding a certain threshold, but does not occur at light intensity below the threshold. Thus, in a photosensitive material capable of two-photon absorption, no light absorption occurs at positions which are slightly departing from the focus of the laser light and thereby have weaker light intensity; this permits the laser light to reach deeper positions in the recording layer, whereby information can be recorded solely in the vicinity of the focus. That is, photosensitive materials having prominent nonlinearity are suitable for an optical recording medium for recording information at arbitrary positions in three dimensions (including the thickness directions of the photosensitive material).

FIG. 1(a) is a schematic general configuration diagram of an optical disk 100 according to Embodiment 1. In FIG. 1(a), numeral 101 indicates an optical disk substrate; numeral 102 indicates a photosensitive material superposed on the optical disk substrate; numeral 103 indicates a control track formed on the optical disk substrate (formed such as to be guided by a groove 110); numeral 104 indicates a recording track superposed in layered structure on the control track 103 (a plurality of recording tracks are formed in parallel to the control layer (a layer having the control track) at diverse positions in the thickness (elevation) directions in the photosensitive material); numeral 105 indicates a segment defined by dividing the control track 103 and the recording tracks 104 into 1280 segments; and numeral 106 indicates a servo region provided in each segment. The servo region 106 is provided both in the control track 103 and in the recording tracks 104.

As shown in the figure, each of the control track 103 and the recording tracks 104 is a spiral region, and extends from the inner circumference to the outer circumference of the optical disk.

In FIG. 1(a) prepared for the purpose of describing the format configuration of the optical disk, the control track 103 and the recording tracks 104 are shown with substantially expanded size in comparison with the overall size of the optical disk.

FIG. 1(b) is a schematic enlarged view of a segment 105 of a control track 103. In FIG. 1(b), the segment 105 comprises: a servo region 106; and a groove 110 having a length 107.

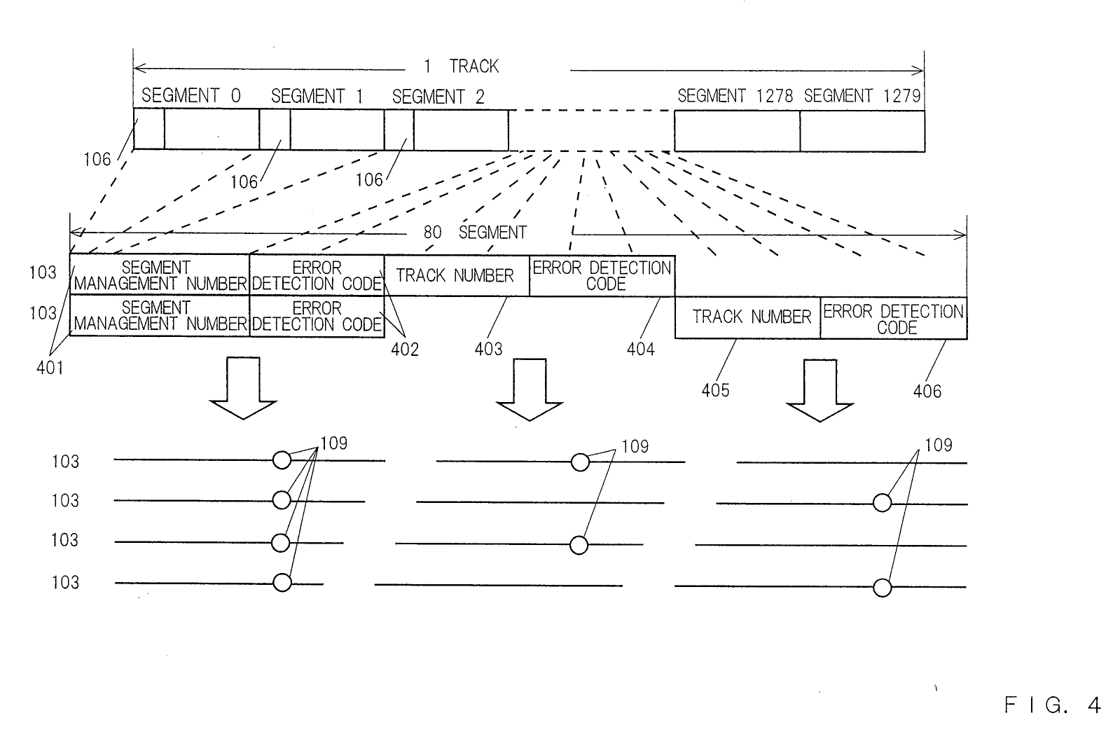

The servo region 106 comprises a clock pit 108 and a one-bit address pit 109 (the address pit 109 is formed or not formed depending on the value 1 or 0 of one-bit data). The clock pit 108 generates a reference pulse used for generating a timing signal, a window signal and the like for reproducing information (such as address information) in each segment. The address pit 109 contains address information (address information which indicates two-dimensional position information in a plane parallel to the control layer 201 of the optical disk). The address information is described later (FIG. 4).

Adjacent grooves 110 are separated from each other by an land 111. The optical pickup apparatus reproduces a tracking control signal in the vicinity of the side walls of the groove 110.

The clock pit 108, the address pit 109 and the groove 110 have a depth of approximately ¼ of the laser wavelength λ.

In Embodiment 1, in order to permit the control apparatus to carry out tracking control by three-beam method, the depths of the address pit 109 and the groove 110 are set to be approximately λ/4; however, the invention is not restricted to this. The depths of the address pit 109 and the groove 110 may be set arbitrarily with considering the relation with the control apparatus. For example, in order to permit the control apparatus to carry out tracking control by push-pull method, the depths of the address pit 109 and the groove 110 may be set to be approximately λ/8. Further, in order to permit the control apparatus to carry out tracking control by three-beam method or push-pull method, the depths of the address pit 109 and the groove 110 may be set to be approximately λ/6.

FIG. 1(c) is a schematic enlarged view of a segment 105 of a recording track 104. In FIG. 1(c), the segment 105 comprises: a servo region 106; and a data recording region 114 having a length 107.

The servo region 106 records a layer identification signal 112. The layer identification signal 112 is recorded at a position departing by a predetermined distance from the clock pit 108 in the control layer, in the longitudinal direction of the control track (or recording track). (The positions of the clock pit 108 and the layer identification signal 112 are different from each other in the elevation directions.)

The data recording region 114 records arbitrary data (such as use data comprising portions with changed optical property and portions with unchanged optical property) or the like. In FIG. 1(c), the shaded portions of the layer identification signal 112 and the data 113 indicate portions with changed optical property of the photosensitive material, while other portions indicate portions with unchanged optical property of the photosensitive material.

In Embodiment 1, the length of the servo region 106 of the control track 103 is the same as the length of the servo region of the recording track 104.

In the present embodiment, nothing is recorded in the region which is a part of the servo region 106 of the recording track 104 and which is superposed on the clock pit 108 provided in the servo region 106 of the control track 103. In another embodiment, the region which is a part of the servo region 106 of the recording track 104 and which is superposed on the clock pit 108 of the control track 103 serves also as a data recording region 114. (That is, the servo region of the recording track 104 becomes a narrower region (a region narrower than the servo region of the control track) only in the vicinity of the recording position of the layer identification signal 112.)

The optical disk 100 according to Embodiment 1 comprises the control track 103 and the recording tracks 104 formed into a spiral shape; each of the control track 103 and the recording tracks 104 is separated into 1280 segments 105 by servo regions 106 provided radially (in the radial directions of the optical disk). The control track 103 and the recording tracks 104 may be formed as concentric circles instead of a spiral.

The servo regions 106 of the segments are provided in equal angular spacing, and occupy the same angular regions; further, the serve regions 106 align with each other in the radial directions of the optical disk.

All the servo regions 106 have shape similar to each other, while the prepits 108, 109 and the layer identification signals 112 are arranged in the same relative positions within the servo regions.

Accordingly, using an angular coordinate system having the origin at the center of the optical disk, a servo region is provided in every 0.28125 degree (=360 degrees/1280 segments) on the optical disk, regardless of the distance from the origin to the position of the control track 103 and the recording tracks 104.

In a predetermined region on the innermost circumference (for example, one circumference of the control track 103 on the optical disk) of the optical disk 100 according to Embodiment 1, the optical property of the photosensitive material is entirely changed on all the recording tracks 104 superposed on (located above) the control track. This region is used for the purpose of calibration of the focal position of an optical pickup apparatus, by an optical disk control apparatus for recording or reproducing a signal into or from the optical disk.

FIG. 2 is a schematic cross sectional view of the optical recording medium according to Embodiment 1 of the invention, taken along line I-I of FIG. 1(a).

On the optical disk substrate 101, provided are: grooves 110 (and control track 103) extending in the directions perpendicular to the plane of paper; and lands 111 located between the grooves. The grooves 110, the lands 111, the prepits 108, 109 and the like constitute the control layer 201.

In the photosensitive material 102, above the grooves 110 (in the thickness directions of the photosensitive material), formed are a plurality (128 layers in the present embodiment) of recording tracks 104 extending in the directions perpendicular to the plane of paper. Each set of recording tracks located at the same elevation measured from the control layer 201 constitutes a recording layer 202 (one of 128 recording layers).

In each recording track, portions with changed optical property of the photosensitive material and portions with unchanged optical property are discretely distributed, typically, in a manner corresponding to data to be recorded, whereby information is recorded. In FIG. 2, for the clearness of the recording track configuration, a portion 113 with changed optical property of the photosensitive material is shown in each recording track.

The step difference between the groove 110 and the land 111 is, for example, 33 nm. The 33 nm corresponds to approximately λ/(8n) for the wavelength region of a blue laser (wavelength of 405 nm). The n indicates the refractive index of the optical disk substrate 101. The material for the optical disk substrate 101 is arbitrary and, for example, composed of polyolefin, glass, PMMA or the like. The refractive index of the material is n=1.52-1.53 for polyolefin, n=1.52 for glass and n=1.49 for PMMA.

The distance between two recording layers adjacent in the elevation directions (the up and down directions in FIG. 2) is, for example, 1 μm, while the distance between two recording layers adjacent in the width directions of the recording track (the left and right directions in FIG. 2) is, for example, 1 μm.

FIG. 2 shows a schematic configuration; thus, the size of each component and the distance between components do not scale accurately.

When the pitch of recording layers adjacent in the up and down directions is λ/(NA×NA) or greater, adjacent signals can be separated. In case that the wavelength is 650 nm and that NA=0.6, the pitch of recording layers is set to be 1.8 μm or greater, whereas in case that the wavelength is 405 nm and that NA=0.85, the pitch of recording layers is set to be 0.56 μm or greater. The wider pitch is more preferable for the convenience of the control of each layer in the elevation directions (the situation is the same in the other embodiments).

When the wavelength of recording reproduction light is denoted by λ, and when the numerical aperture is denoted by NA, in case of Embodiment 1 in which tracking is carried out on the groove, the groove pitch (the distance between two recording layers adjacent in the width directions of the recording track) is preferably set to be approximately (2λ))/(3·NA) or greater. This is for the purpose of stable tracking control. In case that the wavelength is 650 nm and that NA=0.6, the groove pitch is set to be 0.72 μm or greater, whereas in case that the wavelength is 405 nm and that NA=0.85, the groove pitch is set to be 0.32 μm or greater.

Numeral 203 indicates an objective lens of the optical pickup apparatus according to the present embodiment. The optical pickup apparatus according to the present embodiment projects two light beams of P-polarized light and S-polarized light of a blue laser (wavelength of 405 nm).

The two light beams of P-polarized light and S-polarized light are focused on two different points on the same optical axis. The S-polarized light is separated into zeroth-order diffraction light (main beam) and positive and negative first-order diffraction light (side beams), by a reflection grating (not shown) provided in the optical pickup apparatus. The main beam (zeroth-order diffraction light) 204 of the S-polarized light is located on the same optical axis as the P-polarized light, and thereby focused on the groove 110 and the prepits 108, 109 in the control layer. The side beams (positive and negative first-order diffraction light) 205, 206 of the S-polarized light are focused on side walls formed between the groove 110 and the lands 111.

The P-polarized light 207 is focused on an arbitrary recording track 104 (recording track 208 in the case of FIG. 2).

With rotating the optical disk 100, the optical disk control apparatus carries out focus control on the basis of the returned light of the main beam 204 focused on the control layer 201 (for example, by astigmatism method or spot size detection method in the prior art), and carries out tracking control on the basis of the returned light of the side beams 205, 206 (for example, by a prior art three-beam tracking scheme in which tracking control is carried out such as to balance the first-order diffraction light from both the side walls of the groove 110 of the control track).

The optical pickup apparatus controls the P-polarized light 207 so as to be focused on a recording track 104 in the photosensitive material on the same optical axis of the main beam 204 of the S-polarized light. The optical pickup apparatus records or reproduces a signal into or from the recording track, using the P-polarized light 207. Hereafter, the S-polarized light used in focus control and tracking control is referred to as control light, while the P-polarized light 207 is referred to as recording and reproduction light. The light emitting power of the recording and reproduction light is changed correspondingly to a signal to be recorded, whereby the signal is recorded.

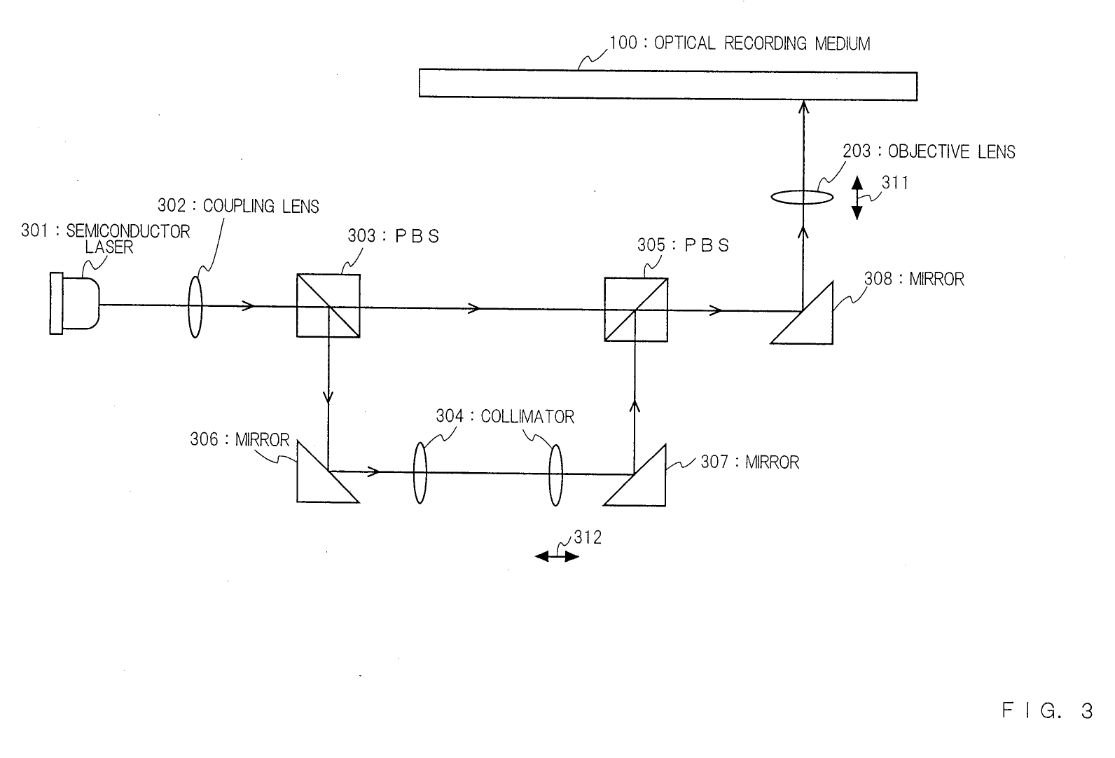

FIG. 3 is a schematic configuration diagram of the optical pickup apparatus according to Embodiment 1 of the invention. (Omitted is the optical system for the side beams for tracking control and the returned light from the recording medium.) Light emitted from a semiconductor laser 301 (blue laser having a wavelength of 405 nm) is substantially parallelized by a coupling lens 302, and then separated into two beams by a polarized beam splitter (PBS, hereafter) 303. One light beam is reflected in a mirror 306, and then variably biased from a parallel beam state (biased in the direction that the focal length increases, in the present embodiment) by a collimator 304 composed of two lenses; after that, this light beam passes a mirror 307; then, with maintaining the substantially parallel state, the light beam is combined with the other light beam into the same optical axis by a PBS 305. The combined two light beams pass a mirror 308, and then are focused by the objective lens 203, thereby being focused on two different points on the same optical axis on the optical recording medium 100.

By selecting the plane of polarization of the light incident on the PBS 303, the intensity ratio between the two light beams is selected arbitrarily. The plane of polarization of the light incident on the PBS 303 may be selected by adjusting the attachment orientation of the semiconductor laser 301 or by inserting a wavelength plate between the semiconductor laser 301 and the PBS 302.

The plane of polarization of the light to be transmitted through the PBS 305 and the plane of polarization of the light to be reflected in the PBS 305 are set perpendicular to each other. In general, a PBS transmits substantially completely the perpendicular oscillation component (P-polarized component) with respect to the incident light, but has a finite reflectance for the parallel oscillation component (S-polarized component). Accordingly, when the light to be transmitted through the PBS 305 is adjusted to be the P-polarized light with respect to the PBS 305, the two light beams are combined without light loss in the PBS 305. The recording and reproduction light needs a high power in recording. Thus, the optical pickup apparatus is preferably configured such as to avoid the light loss of the recording and reproduction light in the PBS. For the simplicity in illustrating the invention, in FIG. 3 showing a schematic configuration of the optical pickup apparatus, the P-polarized light which is transmitted and serves as the recording and reproduction light is depicted as if to be reflected; however, FIG. 3 is not such an accurate drawing in detail. In the present embodiment, the P-polarized light serving as the recording and reproduction light is transmitted through the PBS 305, while the S-polarized light serving as the control light is reflected in the PBS 305.

The light from the semiconductor laser generally has an elliptical spot shape. After the light is substantially parallelized by the coupling lens 302, means (such as a prism) may be provided for converting the spot shape of the light from the semiconductor laser into a substantially circular shape.

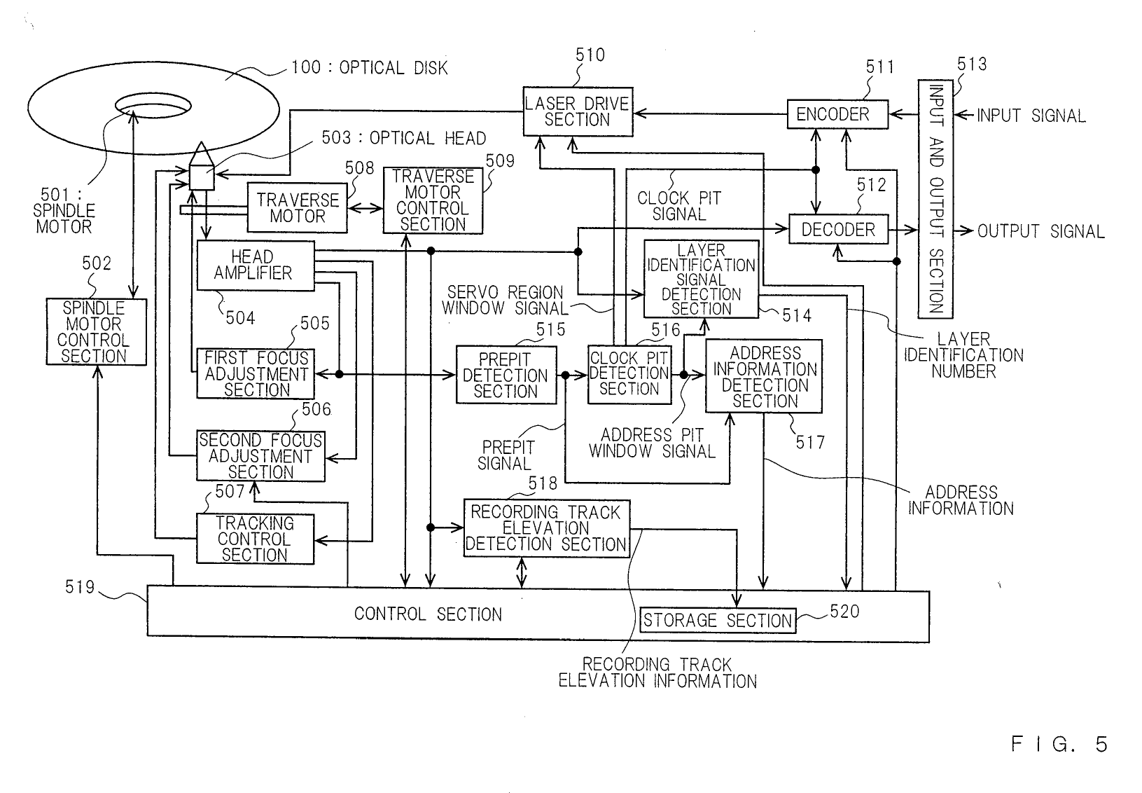

The optical pickup apparatus comprises: a first focus adjustment section (505 in FIG. 5) for moving the objective lens 203 in the optical axis directions (directions indicated by numeral 311); and a second focus adjustment section (506 in FIG. 5) for moving one lens of the collimator 304 in the directions indicated by numeral 312.

When the first focus adjustment section moves the objective lens 203, both focuses (imaging points) of the control light and the recording and reproduction light move; in contrast, when the second focus adjustment section moves one lens of the collimator 304, the focus (imaging point) of the recording and reproduction light moves solely.

The first focus adjustment section automatically adjusts such that the control light (not going through the collimator 304) is focused on the groove 110 (focus control, for example, by astigmatism method or spot size detection method). A tracking control section carries out tracking control such as to equalize the amounts of the returned light from the side beams 205, 206 (for example, by three-beam tracking scheme).

The second focus adjustment section moves one lens of the collimator 304 discretely in the optical path directions (directions 312), and thereby changes the imaging point difference between the control light and the recording and reproduction light discretely by the unit of a predetermined distance (the pitch between two recording tracks adjacent in the elevation directions in FIG. 2, assumed to be a predetermined pitch according to a standard). This permits the focus of the recording and reproduction light to move accurately between the up and down recording layers 202.

During the recording or reproducing of a signal onto or from the recording track 104 of a recording layer 202, the second focus adjustment section normally does not move the lens of the collimator 304. In the recording or reproducing, the focus of the recording and reproduction light is located on the same optical axis as the focus of the control light, and they are in linkage with each other; further, even in case that the optical disk has warpage, the distance from the groove 110 (control layer) of the optical disk to the imaging point of the recording and reproduction light does not change; accordingly, the imaging point of the recording and reproduction light is located correctly above the control track 103 (groove 110). Thus, the recording and reproduction light accurately records or reproduces a signal onto or from the recording track 104.

The returned light of the control light and the recording and reproduction light is appropriately separated by the PBS.

Described below are the address pit 109 and the layer identification signal 112.

The presence or absence of an address pit 109 represents one bit of address data. This corresponds to the distributed address format disclosed in Japanese Laid-Open Patent Publication No. 2001-148125. The distributed address format is described below with reference to FIG. 4. FIG. 4 is a configuration diagram of the distributed address format. A circumference of track of the optical disk is divided into 1280 segments, while the servo region of each of the 1280 segments is assigned with a one-bit address bit.

The 1280 segments 105 in each disk circumference are divided into 16 groups, whereby address information (information based on the presence or absence of address pits) is generated by the unit of an address of 1280/16=80 bits. The 80-bit address information contains: a 7-bit segment management number (position information in the rotational directions) 401; an 11-bit error detection code 402 for the segment management number; a 16-bit track number information (track number of the control track) 403 of an odd-numbered control track 103; a 15-bit BCH-coded error correction information 404 for the track number information of the odd-numbered control track; a 16-bit track number information 405 of an even-numbered control track 103; and a 15-bit BCH-coded error correction information 406 for the track number information of the even-numbered control track.

The segment information provides the angle information of the optical disk. The segment management numbers 401 and the error detection codes 402 for the segment management numbers are aligned in the radial directions. The 16 segment management numbers 401 arranged in each circumference represent the 16 segment management numbers. When the number of segments is counted starting from the 16 segments, the segment number of a segment is identified.

Reading out the track numbers 403, 405, position information in the radial directions is obtained. The track numbers 403, 405 are used as search information in the disk seek and the like. When a servo region 106 contains: a track number information 403 of an odd-numbered control track 103; and an error correction information 404 for the track number information of the odd-numbered control track; the servo region adjacent to this does not contain: a track number information 405 of an even-numbered control track 103; and an error correction information 406 for the track number information of the even-numbered control track. Similarly, when a servo region 106 contains: a track number information 405 of an even-numbered control track 103; and an error correction information 406 for the track number information of the even-numbered control track; the servo region adjacent to this does not contain: a track number information 403 of an odd-numbered control track 103; and an error correction information 404 for the track number information of the odd-numbered control track.

In the 16 address information in each circumference, alternatingly provided at eight positions each in each circumference are: the address information containing a track number information 403 and the like of an odd-numbered control track 103; and the address information containing a track number information 405 and the like of an even-numbered control track 103. This avoids cross talk between adjacent tracks, and thereby prevents misreading of the track number.

The layer identification signal 112 (composed of 18 bits in the present embodiment) contains: a 7-bit layer identification number (0, 1, 2, . . . , 127) assigned to each layer sequentially starting from the layer nearest to the control layer; and an 11-bit error detection code. Each bit of the 18-bit layer identification signal 112 is recorded in each servo region 106 of the recording track 104. In the present embodiment, the 1280 segments 105 in each disk circumference are divided into 16 groups, whereby 16 layer identification signals 112 are repeatedly recorded in each disk circumference in synchronization with the 80-bit address information. The layer identification signal 112 is composed of 18 bits, and hence contains a smaller amount of information than the 80-bit address information; however, the difference of the 62 bits records nothing. The 62 bits may record arbitrary information.

In place of the configuration of the present embodiment, the address information may be concentrated in a specific address region of the recording track, whereby the layer identification signal may be recorded on the recording track superposed on the address region.

The optical disk control apparatus according to Embodiment 1 of the invention is described below with reference to FIG. 5. FIG. 5 is a block diagram of a control apparatus (recording and reproducing apparatus in FIG. 5) for an optical recording medium according to Embodiment 1 of the invention.

In FIG. 5, numeral 100 indicates an optical disk; numeral 501 indicates a spindle motor; numeral 502 indicates a spindle motor control section; numeral 503 indicates an optical head; numeral 504 indicates a head amplifier; numeral 505 indicates a first focus adjustment section; numeral 506 indicates a second focus adjustment section; numeral 507 indicates a tracking control section; numeral 508 indicates a traverse motor; numeral 509 indicates a traverse motor control section; numeral 510 indicates a laser drive section; numeral 511 indicates an encoder; numeral 512 indicates a decoder; numeral 513 indicates an input and output section; numeral 514 indicates a layer identification signal detection section; numeral 515 indicates a prepit detection section; numeral 516 indicates a clock pit detection section; numeral 517 indicates an address information detection section; numeral 518 indicates a recording track elevation detection section; numeral 519 indicates a control section; and numeral 520 indicates a storage section.

The spindle motor 501 control section 502 controls and drives the spindle motor 501 at a predetermined revolution speed in response to an instruction from the control section 519. The spindle motor 501 revolves the optical disk 100 at the predetermined revolution speed.

The optical head 503 comprises: an optical system for recording (FIG. 3) and reproduction in the optical pickup apparatus; a tracking actuator for moving the objective lens 203 in the width directions of the control track (and the recording track); a first focus actuator for moving the objective lens 203 in the optical axis directions; and a second focus actuator for moving a lens of the collimator in the optical path directions. The tracking actuator, the first focus actuator and the second focus actuator are composed of voice coil motors.

Receiving a reproduction signal generated from the control light read out by the reproduction optical system (reproduction signal by astigmatism method), the first focus adjustment section 505 controls and drives the first focus actuator, and thereby moves the objective lens continuously, whereby the control light is focused on the groove 110.

In response to an instruction from the control section 519, the second focus adjustment section 506 controls and drives the second focus actuator, and thereby move the lens of the collimator discretely in equal spacing by the unit of a predetermined distance (pitch between up and down adjacent recording tracks), whereby the recording and reproduction light is focused on a recording track 104 at a target elevation. The optical pickup apparatus according to the present embodiment comprises a position sensor for detecting the position of the lens of the collimator. Receiving the detected position information from the position sensor, the second focus adjustment section 506 moves the above-mentioned one lens of the collimator into the target position, and then maintains the lens in position.

The second focus adjustment section 506 moves the focus of the recording and reproduction light in the up and down directions, using the position of the groove 110 of the control track 103 as the reference. In case that the position where the focus (imaging point) of the recording and reproduction light coincides with the focus of the control light is fixed (for example, in case that the position does not change depending on the environmental condition such as temperature), the second focus adjustment section 506 does not need to obtain a negative feedback signal from the returned light. In contrast, in case that the position where the focus of the recording and reproduction light coincides with the focus of the control light changes, for example, depending on the environmental condition such as temperature, it is preferable to obtain a negative feedback signal from the returned light.

In this case, the focus of the recording and reproduction light is first positioned at the groove 110 of the control track 103, whereby the positioning is carried out by astigmatism method similarly to the case of the control light. This permits the focus of the recording and reproduction light to coincide with the focus of the control light. After that, the focus of the recording and reproduction light is moved discretely by the unit of a predetermined distance, whereby the focus is positioned onto each recording track.

Receiving the detection signals of the returned light of the side beams of the control light, the tracking control section 507 controls and drives the tracking actuator so that the amounts of the returned light from the two side beams coincide with each other.

In the present specification, the set of the optical head, the first focus adjustment section, the second focus adjustment section and the tracking control section is referred to as an optical pickup apparatus.

In response to an instruction from the control section 519, the traverse motor control section 509 drives the traverse motor 508, and thereby moves the optical head 503 in the radial directions of the optical disk 100.

Receiving a reproduction signal of the main beam of the control light, the prepit detection section 515 detects and outputs the reproduction signals (“prepit signals,” hereafter) of the prepits 108, 109.

Receiving the prepit signals, the clock pit detection section 516 outputs: the reproduction signal (“clock pit signal,” hereafter) of the clock pit 108; and an address pit window signal and a servo region window signal generated using the clock pit signal as the reference.

The address pit window signal is a window signal delayed from the clock pit signal by a predetermined time and having a predetermined time width; the reproduction signal (“address pit signal,” hereafter) of the address pit 109 exists within the window signal.

The address information detection section 517 receives the prepit signals (including the address pit signal) and the address pit window signal, and thereby outputs the address pit signal and the address information (outputted in each time when an 80-bit address signal is inputted).

The layer identification signal detection section 514 receives the address pit window signal and the reproduction signal from the recording and reproduction light (the present operation is reproduction), and thereby outputs the information of layer identification number. In the present embodiment, the recording positions (distance from the clock pit in the longitudinal directions of the control track (or the recording track)) are the same for the layer identification signal 112 and the address pit 109; accordingly, the address pit window signal is shared. The clock pit detection section 516 may generate a window signal dedicated for the layer identification signal.

The encoder 511 encodes an input signal (such as a video signal, an audio signal and computer data) inputted from the input and output section, and thereby outputs the result. The encoder 511 determines the output timing of the encoded signal, using the clock pit signal as the reference.

The laser drive section 510 receives the encoded input signal and the servo region window signal (an output signal of the clock pit detection section 516). In recording, the laser drive section 510 writes an encoded signal onto the recording track of the optical disk 100 (that is, for example, does not cause a change in the photosensitive material for the case of a value 0, but causes a change in the photosensitive material for the case of a value 1), during a predetermined time interval not including the servo region interval 106. In the servo region interval 106, even in case of recording, the laser drive section 510 projects laser light at reproduction level in normal cases (no signal can not be recorded in the servo region interval 106, in normal cases). However, in case that the servo region 106 of the recording track 104 of the optical disk 100 is found not to record a layer identification signal 112, the laser drive section 510 may record automatically a layer identification signal 112 (inputted from the control section 519 to the laser drive section 510) into the servo region 106 of the recording track 104.

In reproduction, the laser drive section 510 projects laser light at reproduction level.

The decoder 512 decodes the output signal of the head amplifier 504, and then outputs the decoded signal via the input and output section 513.

The control section 519 is composed of a microcomputer. The control section 519 receives the address information from the address information detection section 517, receives the layer identification number from the layer identification signal detection section 514, and thereby obtains the three-dimensional position information of the light beam. The control section 519 transmits an instruction to the traverse motor control section 509, and thereby moves the position (position on a plane parallel to the control layer 201) of the light beam. In order to change the elevation (layer number) of recording track 104, the control section 519 transmits an instruction to the second focus adjustment section 506, and thereby changes the elevation of the focus of the recording and reproduction light discretely.

When a new optical disk 100 is inserted into the control apparatus, the control apparatus 519 transmits an instruction to the spindle motor control section 502 so as to revolve the spindle motor 501, and then transmits an instruction to the traverse motor control section 509 so as to move the light beam onto the innermost circumference.

As described above, in a predetermined region on the innermost circumference of the optical disk 100, the optical property of the photosensitive material is changed on all the recording tracks 104 superposed on (located above) the control track. (The optical property of the photosensitive material may be changed in all the data recording regions other than the servo regions; alternatively, the optical property of the photosensitive material may be changed in all the segments including the servo regions.) This region is used for the purpose of calibration of the elevation of the focal position; accordingly, recording of this region is carried out preferably in a factory by an optical disk control apparatus in which the elevation of the focal position is accurately controlled.

Then, the control section 519 transmits an instruction to the first focus adjustment section 505, and thereby positions the focuses of the control light and the recording and reproduction light at the groove 110 of the control track 103. Thus, focus control and tracking control of the control light are carried out.

Then, the control section 519 transmits an instruction to the second focus adjustment section 506, and thereby moves the focus of the recording and reproduction light gradually higher starting from the groove 110 of the control track 103. The recording track elevation detection section 518 receives: the reproduction signal of the recording and reproduction light; and the focus elevation information of the recording and reproduction light. (The control section 519 transmits elevation instruction information to the recording track elevation detection section 518.)

The level of the reproduction signal of the recording and reproduction light changes at portions with changed optical property. On the basis of the level of the reproduction signal of the recording and reproduction light and the elevation instruction information from the control section 519, the recording track elevation detection section 518 detects the value of the elevation instruction information from the control section 519 at the position of the recording track (position where the level of the reproduction signal of the recording and reproduction light changes), and then transmits the value to the control section 519. The control section 519 stores, into the storage section 520, the value of the instruction optimum for positioning the focus of the returned light at each recording track. As such, calibrated is the value of the elevation instruction information of the control section 519 for instructing the position of each recording track.

Then, the optical head 503 is moved to a predetermined position where recording or reproduction is to be carried out. The control section 519 transmits an instruction to the first focus adjustment section 505, and thereby positions the focus of the control light at the groove 110 of the control track 103. Thus, focus control and tracking control of the control light are carried out. Then, the control section 519 transmits an instruction to the second focus adjustment section 506, and thereby moves the focus of the recording and reproduction light to the elevation (stored in the storage section 520) of the recording track where recording or reproduction is to be carried out. On the basis of the value read out from the storage section 520, the control section 519 transmits an instruction to the second focus adjustment section 506. The focus of the recording and reproduction light may be temporarily positioned at the groove 110 of the control track 103, whereby focus control may be carried out. After that, the focus of the recording and reproduction light may be positioned at the elevation of the recording track where recording or reproduction is to be carried out. Then, recording or reproduction is carried out.

In reproduction, using the returned light of the recording and reproduction light, the second focus adjustment section 506 may move one lens of the collimator 304 continuously, and thereby changes continuously the difference between the focus of the recording and reproduction light and the focus of the control light, whereby focus control may be carried out on the signal recorded on the recording track 104; this permits more precise signal reproduction.

In recording in layered structure, a signal for identifying the layer is preferably recorded in each layer as is in the present embodiment; this permits easy layer identification in additional recording or reproduction. In case that the signal for identifying the layer is recorded in a portion of recording layer superposed on the portion where the position information of the control layer is recorded, the layer number is identified at the same time as the identification of the two-dimensional position within the recording layer; this permits the identification of the three-dimensional position in the photosensitive material. In general, in recording of signals into a recording medium, the recording is required to be such that a specific signal can be selectively reproduced. The optical recording medium according to the invention meets this requirement.

In reproduction of a signal from the optical recording medium according to the invention, similarly to the case of recording, the disk-shaped optical recording medium is first revolved; then, focus control is carry out on the control layer 201, while tracking control is carried out on the groove 110. After that, continuous reproduction light is focused inside the photosensitive material at a power causing no change in the photosensitive material. The reproduction light is focused on the same optical axis as the control light, whereby selected is a portion of photosensitive material superposed on a specific groove of the control layer 201. When the difference between the imaging points of the control light and the recording and reproduction light is selected from discrete values, a specific layer is selected in the photosensitive material. Accordingly, a specific signal in the photosensitive material 102 is reproduced. The focus control may be carried out such that the difference between the imaging points of the control light and the recording and reproduction light is continuously changed on the basis of the returned light of the reproduction light, and that the reproduction light is focused on a specific layer in the photosensitive material; this permits more precise signal reproduction.

Recording or reproduction of a signal is preferably carried out through the control layer, because the control light is not affected by the photosensitive material. Further, in focus control, the focus control is carried out in the situation that the objective lens approaches the recording medium from a departed position; accordingly, it is preferable that the layer of focus control target is on the side nearer to the objective lens. The transmissivity of the control layer does not change; accordingly, when a signal is recorded or reproduced through the control layer into or from the photosensitive material, the control layer does not affect the signal.

Tracking is carried out on the control layer, while signals are recorded in layered structure along the tracking control signal, whereby data is recorded on the tracks arranged in three dimensions. Further, each layer records a layer identification signal, whereby each track is identified. Accordingly, even when the medium is removed from the recording and reproducing apparatus and then mounted again, or even when the medium is mounted on another recording and reproducing apparatus, tracking control is carried out again, whereby the layer is identified with the layer identification signal; accordingly, the same position in the recording medium is easily identified; this provides the changeability and compatibility of recording media.

In case of the use of a photosensitive material such as a photorefractive crystal which needs no development process for the recorded signal, an additional signal can be recorded. In such a case, the recording and reproduction light is shifted discretely in equal spacing in the photosensitive material, whereby it is determined whether a layer identification signal is recorded or not; then, in case that no layer identification signal is recorded, a layer identification signal is recorded first; then, the additional signal is recorded. In case that a layer identification signal is already recorded, the additional signal is recorded in an unrecorded portion of the layer.

Focus control and tracking control on the control layer are carried out by moving the objective lens on the basis of the signal obtained from the returned light of the control light. Focus control on the signal recorded in layered structure in the photosensitive material is carried out by changing the imaging point difference between the control light and the recording and reproduction light on the basis of the signal obtained from the returned light of the recording and reproduction light. In reproduction by the present apparatus, focus control is carried out on the signal in layered structure; accordingly, the recording and reproduction light is focused on the signal more precisely, whereby the signal is reproduced more securely.

### Embodiment 2

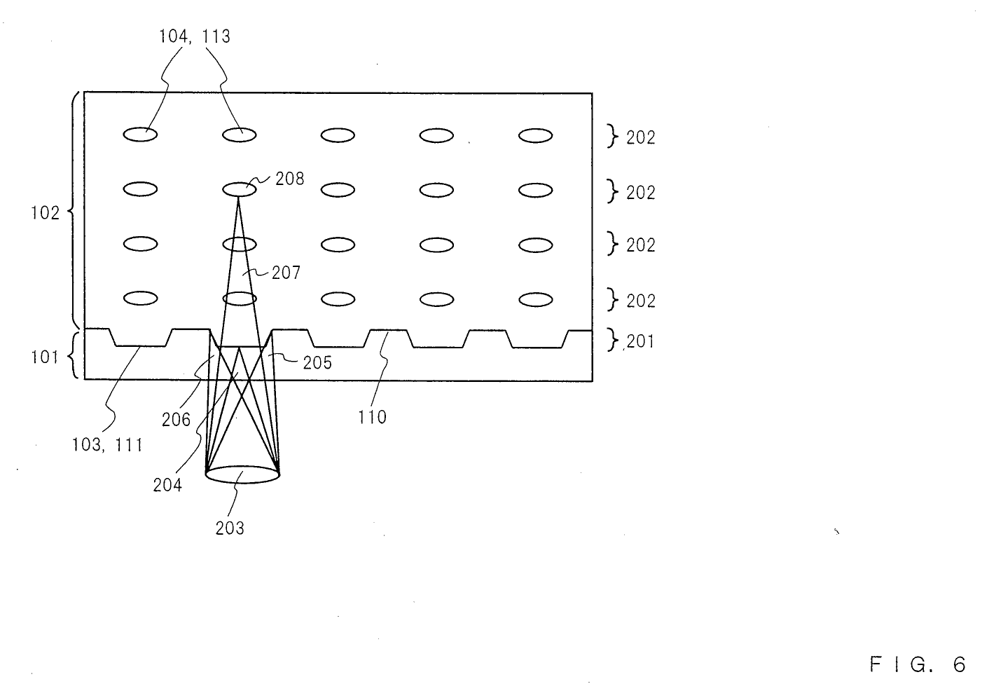

An optical recording medium according to Embodiment 2 is described below with reference to FIG. 6. The optical recording medium according to Embodiment 2 is an optical disk for recording information in three dimensions in a photosensitive material.

The optical recording medium according to Embodiment 2 has the configuration shown in FIG. 1. (The only difference is that the control track 103 runs along the land 111.) The other points are the same as Embodiment 1, and hence the description of FIG. 1 is omitted.

FIG. 6 is a schematic cross sectional view of an optical recording medium according to Embodiment 2 of the invention, taken along line I-I of FIG. 1(a).

In the optical recording medium according to Embodiment 1, the control track 103 has been provided in the groove 110, while the recording tracks 104 have been provided in the positions superposed on the control track 103. In the optical recording medium according to Embodiment 2, a control track 103 is provided in the land 111, while recording tracks 104 are provided in the positions superposed on the control track 103. The other points are the same in the two embodiments.

When the wavelength of the recording reproduction light is denoted by λ, and when the numerical aperture is denoted by NA, in case of Embodiment 2 in which tracking is carried out on the land, the land pitch (the distance between two recording layers adjacent in the width directions of the recording track) is preferably set to be approximately (2λ)/(3·NA) or greater. This is for the purpose of stable tracking control. In case that the wavelength is 650 μm and that NA=0.6, the land pitch is set to be 0.72 nm or greater, whereas in case that the wavelength is 405 nm and that NA=0.85, the land pitch is set to be 0.32 μm or greater.

The first focus adjustment section of the control apparatus for the optical recording medium according to Embodiment 2 focuses the control light on the land 111, and thereby carries out focus control. The tracking control section 507 carries out tracking control on the basis of the side beams projected between the land 111 and the grooves 110. The other points of the control apparatus for the optical recording medium according to Embodiment 2 are the same as Embodiment 1

### Embodiment 3

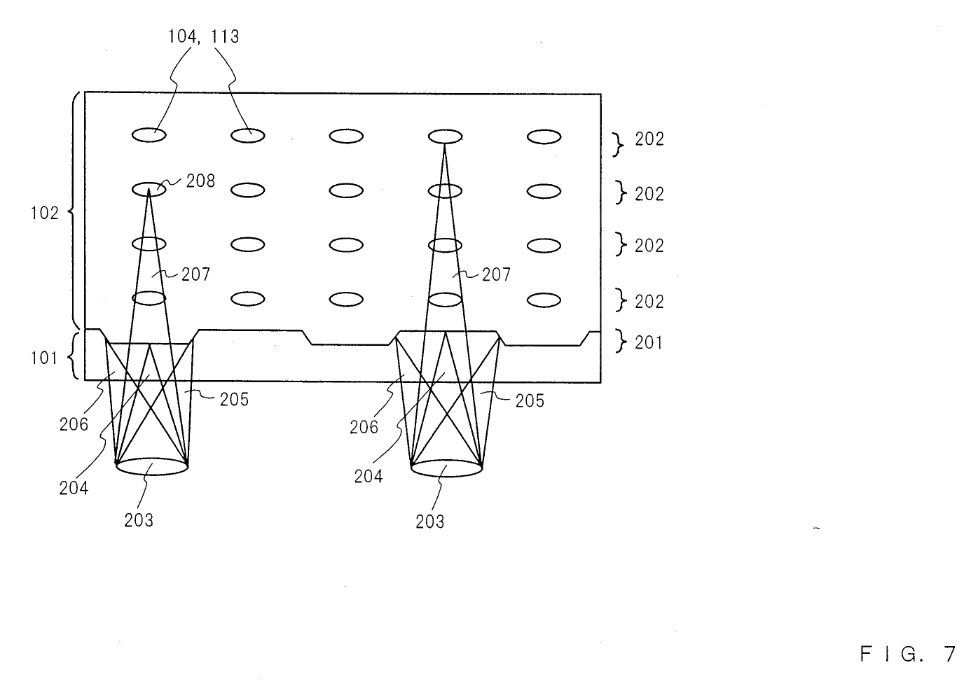

An optical recording medium according to Embodiment 3 is described below with reference to FIG. 7. The optical recording medium according to Embodiment 3 is an optical disk for recording information in three dimensions in a photosensitive material.

The optical recording medium according to Embodiment 3 has the configuration shown in FIG. 1. (The only difference is that the control track 103 runs along both the groove 110 and the land 111.) The other points are the same as Embodiment 1, and hence the description of FIG. 1 is omitted.

FIG. 7 is a schematic cross sectional view of an optical recording medium according to Embodiment 3 of the invention, taken along line I-I of FIG. 1(a).

In the optical recording medium according to Embodiment 1, the control track 103 has been provided in the groove 110, while the recording tracks 104 have been provided in the positions superposed on the control track 103. In the optical recording medium according to Embodiment 3, the land/groove scheme is adopted; thus, the control track 103 having a spiral shape runs along the groove and the land alternatingly. Recording tracks 104 are provided in the positions superposed on the control track 103.

The control track 103 varies from a groove to an land or from an land to a groove, in each segment at a predetermined angle of the optical recording medium. The other points are the same in the two embodiments.

When the wavelength of the recording reproduction light is denoted by X, and when the numerical aperture is denoted by NA, in case of Embodiment 3 in which tracking is carried out on the groove and the land, the groove-land pitch (the distance between two recording layers adjacent in the width directions of the recording track) is preferably set to be approximately (2λ)/(3·NA) or greater. This is for the purpose of stable tracking control. In case that the wavelength is 650 nm and that NA=0.6, the groove-land pitch is set to be 0.72 μm or greater, whereas in case that the wavelength is 405 nm and that NA=0.85, the groove-land pitch is set to be 0.32 μm or greater.

The address information detection section 517 of the control apparatus for the optical recording medium according to Embodiment 3 outputs a control signal at high level when the control track goes along the groove and at low level when the control track goes along the land. Receiving this control signal, the first focus adjustment section switches the internal setting thereof, and then carries out focus control and tracking control. In the same recording layer, the distance between the focus of the control light and the focus of the recording and reproduction light is constant; accordingly, the elevation of the recording track along the groove and the elevation of the recording track along the land are different from each other by the difference between the elevations of the groove and the land. The other points of the control apparatus for the optical recording medium according to Embodiment 3 are the same as Embodiment 1

### Embodiment 4

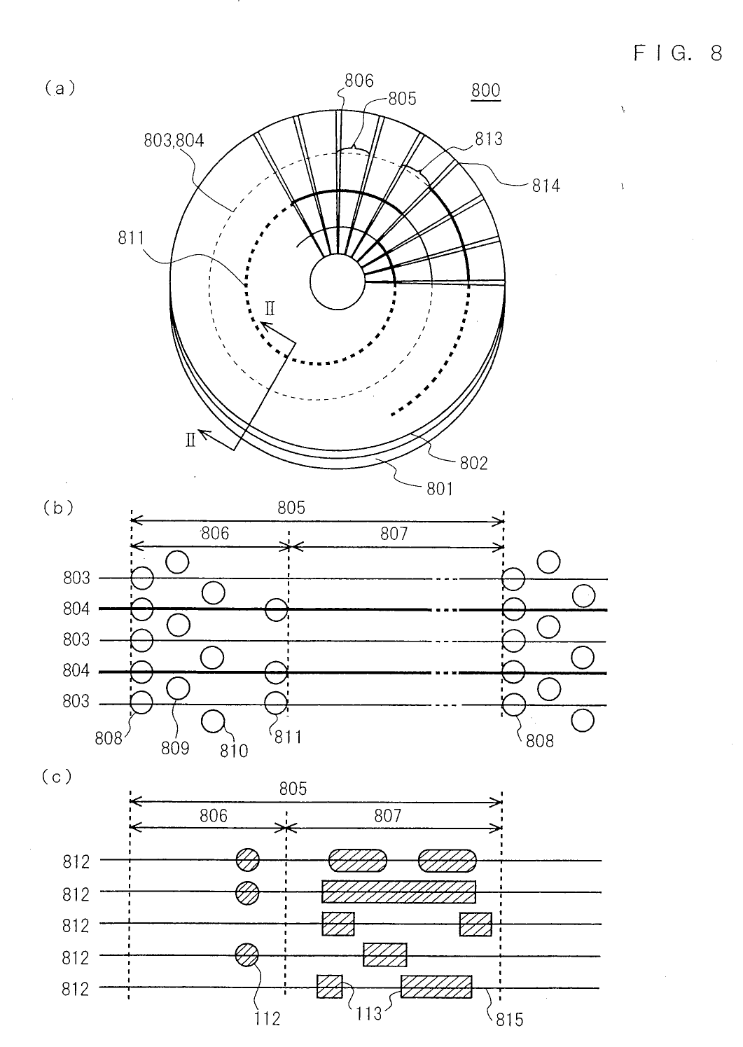

An optical recording medium according to Embodiment 4 is described below with reference to FIGS. 8-10. The optical recording medium according to Embodiment 4 is an optical disk for recording information in three dimensions in a photosensitive material.

In Embodiment 4, the photosensitive material comprises a photorefractive crystal (such as LiNbO₃, BaTiO₃ and LiIO₃) having prominent nonlinearity with respect to light intensity. In place of this, the photosensitive material may be composed of a resin containing photochromic molecules (such as spirobenzopyran) distributed therein, a photopolymer, a bichromate gelatin, a photographic emulsion film.

FIG. 8(a) is a schematic general configuration diagram of an optical disk 800 according to Embodiment 4. In FIG. 8(a), numeral 801 indicates an optical disk substrate; numeral 802 indicates a photosensitive material superposed on the optical disk substrate; numerals 803 and 804 indicate a control track formed on the optical disk substrate (formed such as to be guided by wobble pits 809, 810); numeral 812 indicates a recording track superposed in layered structure on the control track 803, 804 (a plurality of recording tracks are formed in parallel to the control layer, at diverse positions in the thickness (elevation) directions in the photosensitive material); numeral 805 indicates a segment defined by dividing the control track 803, 804 and the recording tracks 812 into 1280 segments; and numeral 806 indicates a servo region provided in each segment. The servo region 806 is provided both in the control track 803, 804 and in the recording tracks 104.

As shown in the figure, each of the control track 803, 804 and the recording tracks 812 is a spiral region, and extends from the inner circumference to the outer circumference of the optical disk.

In FIG. 1(a) prepared for the purpose of describing the format configuration of the optical disk, the control track 803, 804 and the recording tracks 812 are shown with substantially expanded size in comparison with the overall size of the optical disk.

The control track 803, 804 is a track guided by wobble pits 809, 810. A wobble pit is shared by two control tracks 803, 804 enclosing the wobble pit. When the light beam goes along the control track 803, the reproduction signals of the wobble pits 809, 810 are read out in the order of left and right; in contrast, when the light beam goes along the control track 804, the reproduction signals of the wobble pits 809, 810 are read out in the order of left and right. This is the only difference between the control tracks 803, 804.

When the light beam goes along the control track, the control tracks 803, 804 alternate with each other once in each circumference (at a position aligned in a radial direction, that is, at the same angle). The control tracks 803, 804 alternate with each other at the transition point from the end of a servo region 814 to a segment 813.

In FIG. 8(b) which is a schematic enlarged view of a segment 805 of the track 803, 804, the segment 805 comprises a servo region 806. The region other than the servo region 806 and having a length 807 is flat and provided with nothing.

The servo region 806 comprises a clock pit 808, wobble pits 809, 810 and a one-bit address pit 811. (The address pit is the same as Embodiment 1, and hence the description is omitted.) The clock pit 808 generates a reference pulse used for generating a timing signal, a window signal and the like for reproducing information (such as address information) in each segment.

The optical pickup apparatus reproduces tracking control signals from the wobble pits 809, 810. The optical pickup apparatus carries out tracking control such as to equalize the levels of the reproduction signals from the wobble pits 809, 810 (by a prior art sampling control scheme). As a result, the control track 803, 804 is a path having the same distance from the two wobble pits 809, 810.

FIG. 8(c) is a schematic enlarged view of a segment 805 of a recording track 812. In FIG. 8(c), the segment 805 comprises: a servo region 806; and a data recording region 815 having a length 807.

The servo region 806 records a layer identification signal 112. The layer identification signal 112 is recorded at a position departing by a predetermined distance (this distance is different from any distance from the clock pit 808 to the wobble pits 809, 810 and the address pit 811) from the clock pit 808 in the control layer, in the longitudinal direction of the control track (or recording track). (The positions of the clock pit 808 and the layer identification signal 112 are different from each other in the elevation directions.)

Information contained in the layer identification signal is the same as that of Embodiment 1, and hence the description is omitted.

The data recording region 815 records arbitrary data (such as use data comprising portions with changed optical property and portions with unchanged optical property) or the like. In FIG. 8(c), the shaded portions of the layer identification signal 112 and the data 113 indicate portions with changed optical property of the photosensitive material, while other portions indicate portions with unchanged optical property of the photosensitive material.

In Embodiment 4, the length of the servo region 806 of the control track 803, 804 is the same as the length of the servo region 806 of the recording track 812.

The optical disk 800 according to Embodiment 4 comprises the control track 803, 804 and the recording tracks 812 formed into a spiral shape; each of the control track 803, 804 and the recording tracks 812 is separated into 1280 segments 805 by servo regions 806 provided radially (in the radial directions of the optical disk). The control track 803, 804 and the recording tracks 812 may be formed as concentric circles instead of a spiral.

The servo regions 806 of the segments are provided in equal angular spacing, and occupy the same angular regions; further, the serve regions 806 align with each other in the radial directions of the optical disk.

All the servo regions 806 have shape similar to each other, while the prepits 808-811 and the layer identification signals 112 are arranged in the same relative positions within the servo regions.

Accordingly, using an angular coordinate system having the origin at the center of the optical disk, a servo region is provided in every 0.28125 degree (=360 degrees/1280 segments) on the optical disk, regardless of the distance from the origin to the position of the control track 803, 804 and the recording tracks 812.

In a predetermined region (for example, the first segment 813 after the control track has been switched) of the optical disk 800 according to Embodiment 4, the optical property of the photosensitive material is changed on all the recording tracks 812 superposed on (located above) the control track. This region is used for the purpose of calibration of the focal position of an optical pickup apparatus, by an optical disk control apparatus for recording or reproducing a signal into or from the optical disk.

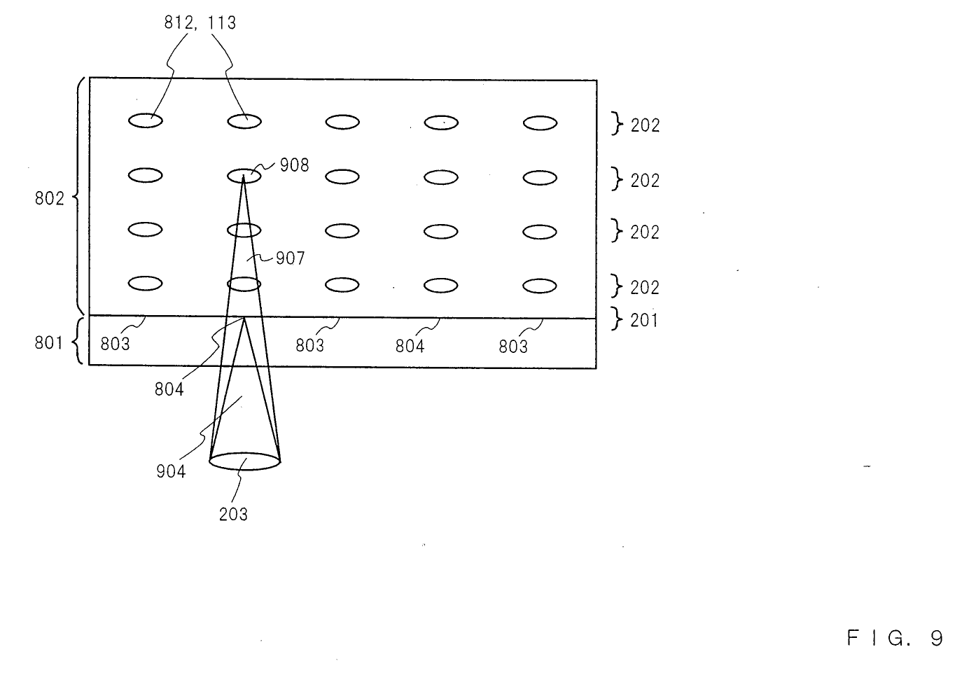

FIG. 9 is a schematic cross sectional view of the optical recording medium according to Embodiment 4 of the invention, taken along line II-II of FIG. 8(a) (along a plane containing the data recording region).

The photosensitive material 802 is superposed on the flat optical disk substrate 801. The boundary layer between the optical disk substrate 801 and the photosensitive material 802 constitutes the control layer 201. In the control layer 201, a plurality of control tracks extend in the directions perpendicular to the plane of paper.

In the photosensitive material 802, above the control track 803, 804 (in the thickness directions of the photosensitive material), formed are a plurality (128 layers, in the present embodiment) of recording tracks 812 extending in the directions perpendicular to the plane of paper. Each set of recording tracks located at the same elevation measured from the control layer 201 constitutes a recording layer 202 (one of 128 recording layers).

In each recording track, portions with changed optical property of the photosensitive material and portions with unchanged optical property are discretely distributed, typically, in a manner corresponding to data to be recorded, whereby information is recorded. In the cross sectional views shown in FIG. 8, for the clearness of the recording track configuration, a portion 113 with changed optical property of the photosensitive material is shown in each recording track.

The distance between two recording layers adjacent in the elevation directions (the up and down directions in FIG. 9) is, for example, 1 μm, while the distance between two recording layers adjacent in the width directions of the recording track (the left and right directions in FIG. 9 is, for example, 1 μm.

FIG. 9 shows a schematic configuration; thus, the size of each component and the distance between components do not scale accurately.

Numeral 203 indicates an objective lens of the optical pickup apparatus according to the present embodiment. The optical pickup apparatus according to the present embodiment projects two light beams (a first light and a second light, hereafter) of a blue laser (wavelength of 405 nm).

The two light beams are focused on two different points on the same optical axis. The first light 904 is focused on the control track 803, 804 (including the prepits 808-811). The second light 907 is focused on an arbitrary recording track 812 (recording track 908 in the case of FIG. 9).

With rotating the optical disk 800, the optical disk control apparatus carries out focus control on the basis of the returned light of the first light 904 focused on the control layer 201 (for example, by astigmatism method or spot size detection method in the prior art), and carries out tracking control on the basis of the returned light of the first light 904 from the prepits 809, 810 (by a prior art sampling control scheme).

The optical pickup apparatus controls the second light 907 so as to be focused on a recording track 812 in the photosensitive material on the same optical axis of the first light 904. The optical pickup apparatus records or reproduces a signal into or from the recording track, using the second light 907. Hereafter, the first light 904 used in focus control and tracking control is referred to as control light, while the second light 907 is referred to as recording and reproduction light. The light emitting power of the recording and reproduction light is changed correspondingly to a signal to be recorded, whereby the signal is recorded.

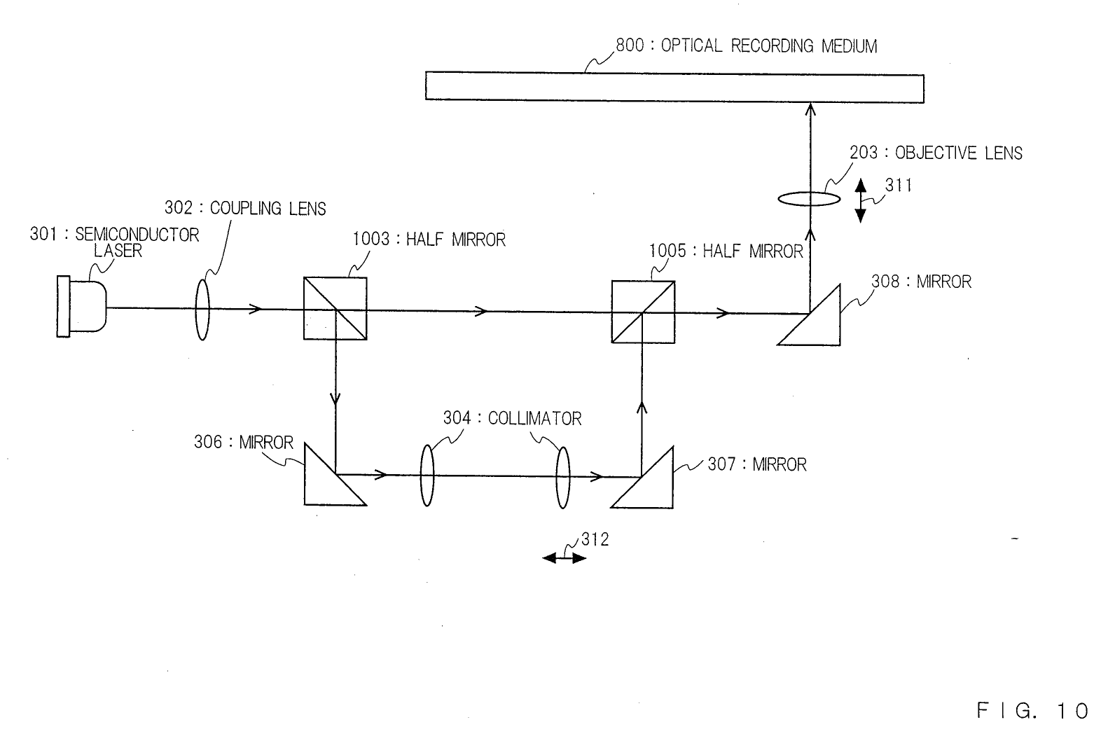

FIG. 10 is a schematic configuration diagram of an optical pickup apparatus according to Embodiment 4 of the invention. (Omitted is the optical system for the returned light from the recording medium. Like parts to FIG. 3 are designated by like numerals.) Light emitted from a semiconductor laser 301 (blue laser having a wavelength of 405 nm) is substantially parallelized by a coupling lens 302, and then separated into two beams by a half-mirror 1003. One light beam is reflected in a mirror 306, and then variably biased from a parallel beam state (biased in the direction that the focal length increases, in the present embodiment) by a collimator 304 composed of two lenses; after that, this light beam passes a mirror 307; then, with maintaining the substantially parallel state, the light beam is combined with the other light beam into the same optical axis by a half-mirror 1005. The combined two light beams pass a mirror 308, and then are focused by the objective lens 203, thereby being focused on two different points on the same optical axis on the optical recording medium 800.

The reflectivities of the half-mirrors 1003, 1005 are selected depending on the desired light intensity ratio of the two light beams obtained in the optical recording medium 800. In case that the reflectivities are 50% each, the intensities of the two light beams are the same.

The light from the semiconductor laser generally has an elliptical spot shape. After the light is substantially parallelized by the coupling lens 302, means (such as a prism) may be provided for converting the spot shape of the light from the semiconductor laser into a substantially circular shape.

The optical pickup apparatus comprises: a first focus adjustment section (505 in FIG. 5) for moving the objective lens 203 in the optical axis directions (directions indicated by numeral 311); and a second focus adjustment section (506 in FIG. 5) for moving one lens of the collimator 304 in the directions indicated by numeral 312.

When the first focus adjustment section moves the objective lens 203, both focuses (imaging points) of the control light and the recording and reproduction light move; in contrast, when the second focus adjustment section moves one lens of the collimator 304, the focus (imaging point) of the recording and reproduction light moves solely.

The first focus adjustment section automatically adjusts such that the control light (not going through the collimator 304) is focused on the control track 803, 804 (focus control, for example, by astigmatism method or spot size detection method). The tracking control section 507 (FIG. 5) carries out tracking control such as to equalize the amounts of the returned light from the two wobble pits 809, 810 (sampling control scheme).

The second focus adjustment section moves one lens of the collimator 304 discretely in the optical path directions (directions 312), and thereby changes the imaging point difference between the control light and the recording and reproduction light discretely by the unit of a predetermined distance (the pitch between two recording tracks adjacent in the elevation directions in FIG. 9, assumed to be a predetermined pitch according to a standard). This permits the focus of the recording and reproduction light to move accurately between the up and down recording layers 202.

During the recording or reproducing of a signal onto or from the recording track 812 of a recording layer 202, the second focus adjustment section normally does not move the lens of the collimator 304. In the recording or reproducing, the focus of the recording and reproduction light is located on the same optical axis as the focus of the control light, and they are in linkage with each other; further, even in case that the optical disk has warpage, the distance from the control track 803, 804 (control layer) of the optical disk to the imaging point of the recording and reproduction light does not change; accordingly, the imaging point of the recording and reproduction light is located correctly above the control track 803, 804. Thus, the recording and reproduction light accurately records or reproduces a signal onto or from the recording track 812.

The position where a signal is recorded in the control track 803, 804 differs from the position where a signal is recorded in the recording track 812; accordingly, these signals are not superposed.

The clock pit detection section 516 (FIG. 5) may extract a clock pit signal which has a large level change and is read out at a constant timing, and then generate a predetermined window signal, using the extracted clock pit signal; this permits accurate separation of the returned light signals of the control light and the recording and reproduction light.

The optical disk control apparatus according to Embodiment 4 has the same configuration as that of Embodiment 1 (FIG. 5). The configuration and the operation of the optical head 503, the tracking control section 507 and the clock pit detection section 516 are different (as described above); however, the operation of the other blocks are the same.

Even in the case of Embodiments 1-3 where grooves and/or lands are provided and where tracking control is carried out using side beams, as long as the prepit signal in the control track is not located in the same position of the recording signal in the recording track (for example, the recording position of the address information is displaced from the recording position of the layer identification signal), focus control and tracking control can be carried out at the same time as the signal recording and reproduction, using only one laser without the use of polarization similarly to the case of the control apparatus according to Embodiment 4.

### Embodiment 5

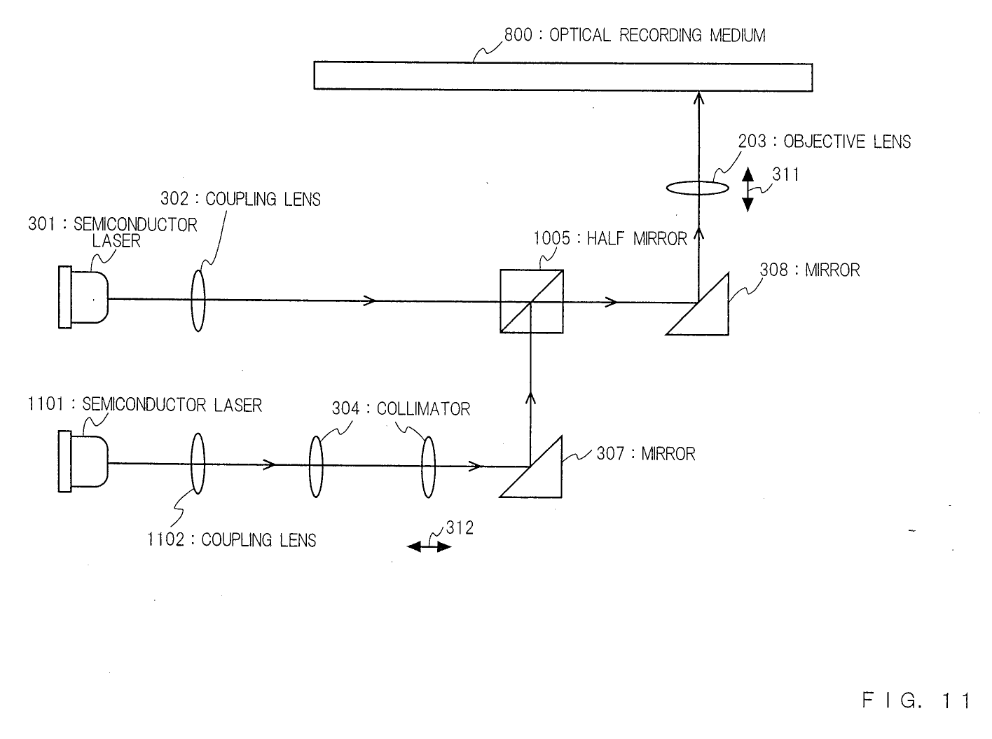

An optical pickup apparatus according to Embodiment 5 is described below with reference to FIG. 11. The optical pickup apparatus according to Embodiment 5 records or reproduces a signal into or from an optical recording medium identical to that of Embodiment 4.

FIG. 11 is a schematic configuration diagram of an optical pickup apparatus according to Embodiment 5 of the invention. (Omitted is the optical system for the returned light from the recording medium. Like parts to FIGS. 3 and 10 are designated by like numerals.) In the optical pickup apparatus according to Embodiment 4 (FIG. 10), light emitted from a semiconductor laser 301 has been separated into two beams by a half-mirror 1003. In contrast, the optical pickup apparatus according to Embodiment 5 comprises two semiconductor lasers 301, 1101 (each being a blue laser having a wavelength of 405 nm). The other points are the same in the two embodiments.

The light beams emitted from the two semiconductor lasers 301, 1101 are substantially parallelized by coupling lenses 302, 1102, respectively. The light beam (recording and reproduction light) emitted from the semiconductor laser 1101 is variably biased from a parallel beam state (biased in the direction that the focal length increases, in the present embodiment) by a collimator 304 composed of two lenses; after that, this light beam passes a mirror 307; then, with maintaining the substantially parallel state, the light beam is combined with the light beam (control light) emitted from the semiconductor laser 301, into the same optical axis by a half-mirror 1005. The combined two light beams pass a mirror 308, and then are focused by the objective lens 203 (the first focus adjustment section controls the focal position of the objective lens 203), thereby being focused on two different points on the same optical axis on the optical recording medium 800. The second focus adjustment section controls the position of one lens of the collimator 304, and thereby moves the imaging position of the light emitted from the semiconductor laser 1101.

When the first focus adjustment section moves the objective lens 203, both focuses (imaging points) of the control light and the recording and reproduction light move; in contrast, when the second focus adjustment section moves one lens of the collimator 304, the focus (imaging point) of the recording and reproduction light moves solely.

The use of two semiconductor lasers permits independent power control of the recording and reproduction light (the power of the irradiation beam needs to be changed in mark recording, space recording and reproduction) and the control light (a constant power is preferred).

In case that the two semiconductor lasers 301, 1101 are replaced by two lasers each having a different wavelength (for example, a red laser having a wavelength of 660 nm and a blue laser having a wavelength of 405 nm), the returned light is easily separated, for example, using a dichroic mirror.

Accordingly, the optical pickup apparatus according to Embodiment 5 comprising two lasers each having a different wavelength can record or reproduce a signal into or from any one of the above-mentioned optical recording media including one according to Embodiment 4.

Preferably, the light of a laser having the longer wavelength (for example, 660 nm) is used as the control light, while the light of a laser having the shorter wavelength (for example, 405 nm) is used as the recording and reproduction light. The laser having the shorter wavelength can record data at higher density.

The operation of the control apparatus for an optical recording medium comprising the optical pickup apparatus according to the present embodiment is the same as the above-mentioned embodiments (FIG. 5).

### Embodiment 6

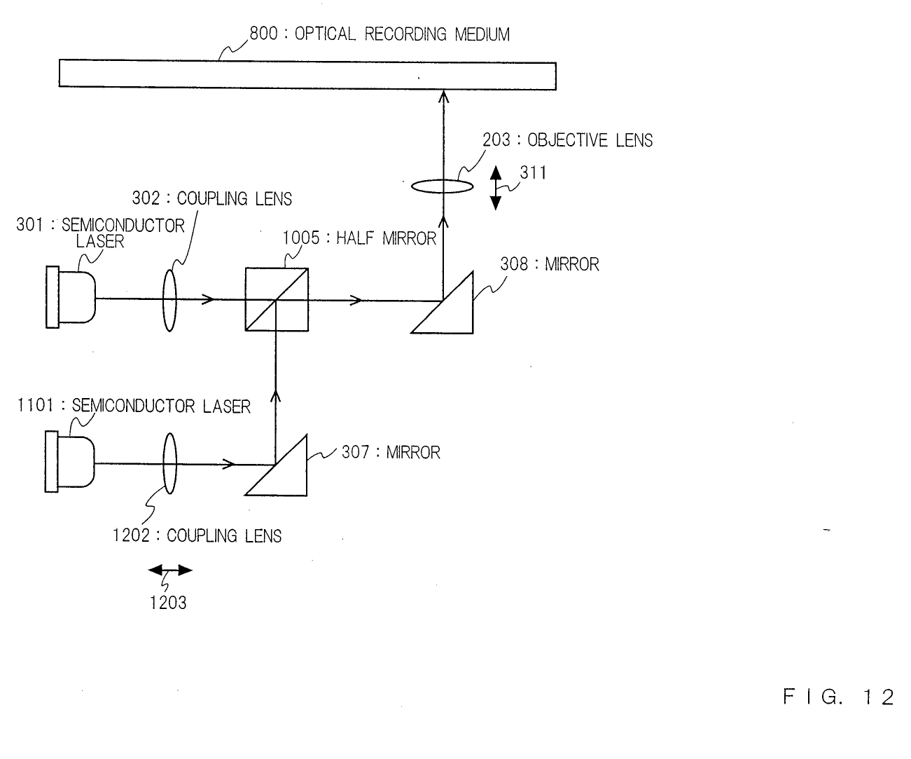

An optical pickup apparatus according to Embodiment 6 is described below with reference to FIG. 12. The optical pickup apparatus according to Embodiment 6 records or reproduces a signal into or from an optical recording medium identical to that of Embodiment 4.

FIG. 12 is a schematic configuration diagram of an optical pickup apparatus according to Embodiment 6 of the invention. (Omitted is the optical system for the side beams, the returned light from the recording medium and the like. Like parts to FIGS. 3, 10 and 11 are designated by like numerals.) In the optical pickup apparatus according to Embodiment 5 (FIG. 11), the light beam emitted from the semiconductor laser 1101 has been biased from a parallel beam state by a collimator 304 composed of two lenses. In contrast, the optical pickup apparatus according to Embodiment 6 does not comprise the collimator 304; thus, the second focus adjustment section directly moves the coupling lens 1102 variably in the optical path directions, and thereby biases the light emitted from the semiconductor laser 1101, from a parallel beam state, whereby the imaging point moves. The other points are the same in the two embodiments.

In FIG. 12, the light beam emitted from the semiconductor laser 301 (a blue laser having a wavelength of 405 nm) is substantially parallelized by the coupling lens 302. The light beam emitted from the semiconductor laser 1101 (a blue laser having a wavelength of 405 nm) is variably biased from a parallel beam state (biased in the direction that the focal length increases, in the present embodiment) depending on the position of the movable coupling lens 1202. The light beam (recording and reproduction light) emitted from the semiconductor laser 1101 and transmitted through the coupling lens 1202 passes a mirror 307; then, with maintaining the substantially parallel state, the light beam is combined with the light beam (control light) emitted from the semiconductor laser 301, into the same optical axis by a half-mirror 1005. The combined two light beams pass a mirror 308, and then are focused by the objective lens 203 (the first focus adjustment section controls the focal position of the objective lens 203), thereby being focused on two different points on the same optical axis on the optical recording medium 800.

When the first focus adjustment section moves the objective lens 203, both focuses (imaging points) of the control light and the recording and reproduction light move. When the second focus adjustment section changes the distance between the coupling lens 1202 and the semiconductor laser 1101 (in the directions 1203), the deviation of the recording and reproduction light from the parallel beam state is changed, whereby the focus (imaging point) of the recording and reproduction light moves solely. As a result, the relative position of the imaging point of the recording and reproduction light changes relatively to the imaging point of the control light (on the same optical axis).

In reproduction, by moving the coupling lens 1202, the focus difference between the recording and reproduction light and the control light may be continuously moved; then, the peak in the signal level of the returned light of the recording and reproduction light may be detected, whereby focus control may be carried out on the signal recorded on the recording track of the optical recording medium 800. This permits more precise focus control and accordingly signal reproduction. As a reference signal for the focus control in the recording layer, a one-bit signal for focus control may be recorded in every servo region in every recording track. For example, for the purpose of focus control, a clock signal may be recorded in every servo region 806 in every recording track, in the position superposed on the clock pit 808 (that is, in the same position).

For example, using the clock pit signal as the reference, the output level of the clock signal is processed by sample hold (alternatively, peak hold within a window including the clock signal), whereby the above-mentioned calibration is carried out.

The control section 519 transmits an instruction to the second focus adjustment section 506, and thereby moves the focus of the recording and reproduction light gradually higher starting from the groove 110 of the control track 103. The recording track elevation detection section 518 receives: the sample-hold value (or peak-hold value) of the clock signal; and the focus elevation information of the recording and reproduction light. (The control section 519 transmits elevation instruction information to the recording track elevation detection section 518.) On the basis of the sample-hold value (or peak-hold value) of the clock signal and the elevation instruction information from the control section 519, the recording track elevation detection section 518 detects the value of the elevation instruction information from the control section 519 at the position of the recording track (position where the level of the reproduction signal of the recording and reproduction light changes), and then transmits the value to the control section 519. The control section 519 stores, into the storage section 520, the value of the instruction optimum for positioning the focus of the reproduction light at each recording track.

The recording and reproduction light is projected to the control track, and temporarily adjusted such as to be focused on the same position, using a focus error signal obtained from the returned light of the recording and reproduction light; after that, the imaging point of the recording and reproduction light is changed discretely; according to this procedure, the imaging point difference between the control light and the recording and reproduction light is maintained stably to be a discrete value.

In case that the two semiconductor lasers 301, 1101 are replaced by two lasers each having a different wavelength (for example, a red laser having a wavelength of 660 nm and a blue laser having a wavelength of 405 nm), the returned light is easily separated, for example, using a dichroic mirror or a dichroic filter.

The planes of polarization of the two semiconductor lasers 301, 1101 may be changed with each other. In case that the planes of polarization are different from each other, the returned light of the control light and the returned light of the recording and reproduction light can be separated from each other, using a polarized beam splitter, a crystal polarizer, or the like.

Accordingly, the optical pickup apparatus according to the present embodiment can record or reproduce a signal into or from any one of the above-mentioned optical recording media including one according to Embodiment 4. The operation of the control apparatus for an optical recording medium comprising the optical pickup apparatus according to the present embodiment is the same as the above-mentioned embodiments.

### Embodiment 7

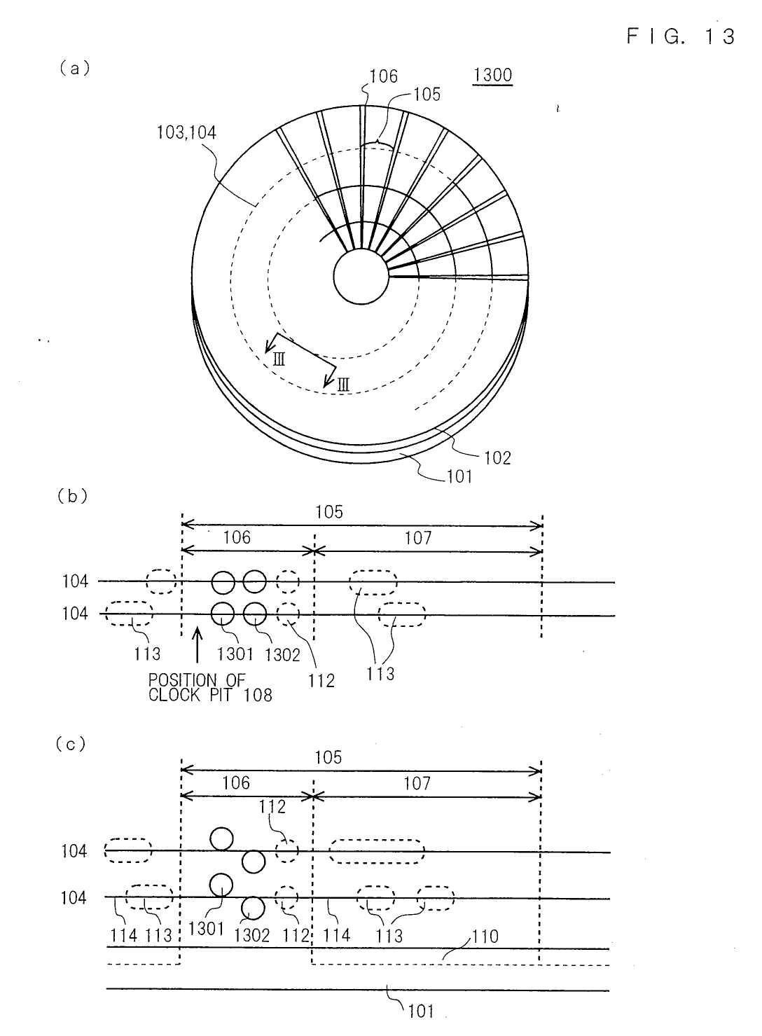

An optical recording medium, an optical pickup apparatus and a control apparatus for an optical recording medium according to Embodiment 7 are described below with reference to FIGS. 13-17.

The optical recording medium according to Embodiment 7 is an optical disk for recording information in three dimensions in a photosensitive material.

In Embodiment 7, the photosensitive material is composed of a photorefractive crystal (such as LiNbO₃, BaTiO₃ and LiO₃) having prominent nonlinearity with respect to light intensity. In place of this, the photosensitive material may be composed of a resin containing photochromic molecules (such as spirobenzopyran) distributed therein, a photopolymer, a bichromate gelatin, a photographic emulsion film.

FIG. 13(a) is a schematic general configuration diagram of an optical disk 1300 according to Embodiment 7. FIG. 13(a) is the same as FIG. 1(a), and hence the description is omitted.

The schematic enlarged view of a segment 105 of a control track 103 is the same as shown in FIG. 1(b), and hence the drawing and the description are omitted.

FIG. 13(b) is a schematic enlarged view of a segment 105 of a recording track 104 (the optical disk is viewed from the above). FIG. 13(c) is a schematic cross sectional view of the optical recording medium according to Embodiment 7 of the invention, taken along line III-III of FIG. 13(a) (along a plane parallel to the recording track 104).

In FIG. 13(b), the segment 105 comprises: a servo region 106; and a data recording region 114 having a length 107. The servo region 106 records: wobble signals 1301, 1302 wobbled up and down (in the thickness directions of the photosensitive material) from diverse positions along the recording track; and a layer identification signal 112. The other points are the same in the two optical recording media according to Embodiments 1 and 7.

An optical disk apparatus (reproduction is solely possible for the wobble signals 1301, 1302) used by a user or the like carries out focus control of the recording and reproduction light, using the wobble signals 1301, 1302 wobbled up and down (by sampling control). This permits the optical disk control apparatus according to Embodiment 7 to carry out precise focus control of the recording and reproduction light.

The control apparatus used by a user or the like cannot record wobble signals 1301, 1302 into the optical recording medium; accordingly, an optical recording medium manufacturer uses a special and later-described control apparatus for an optical recording medium, and thereby records wobble signals 1301, 1302 wobbled up and down.

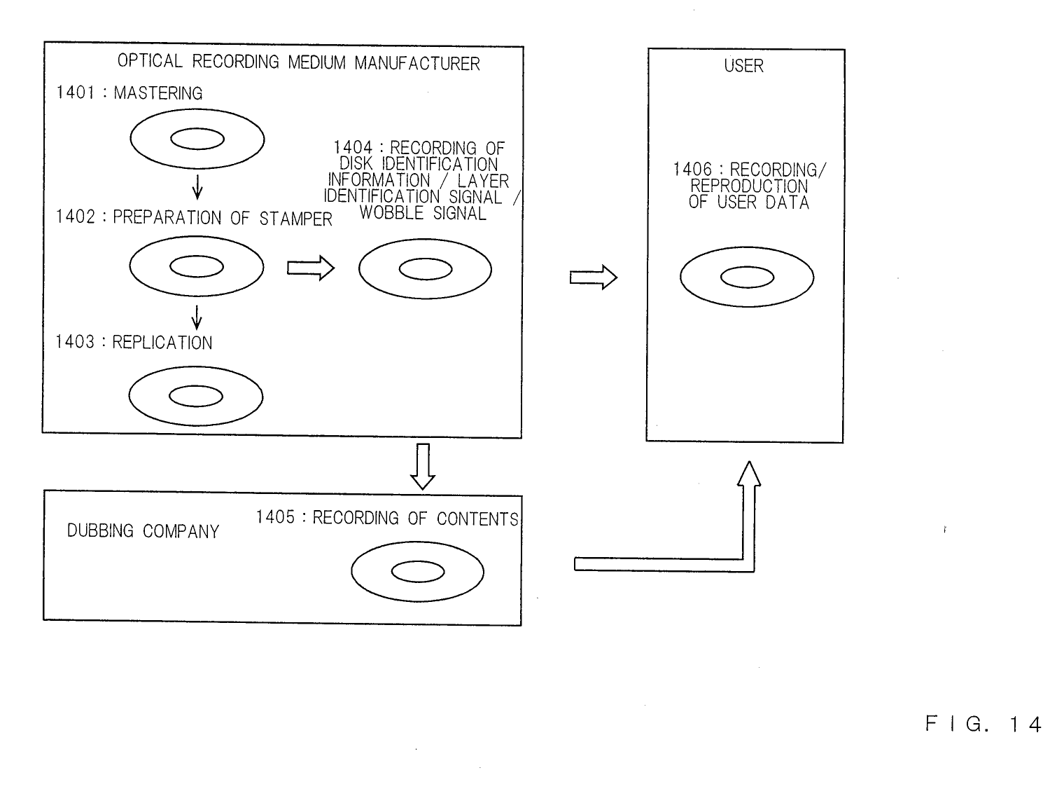

FIG. 14 is a chart showing a flow from the fabrication of an optical recording medium to the use of the optical recording medium by a user. In a mastering process in Step 1401, the optical recording medium manufacturer fabricates first a master disk. In Step 1402, a stamper is fabricated from the maser disk. In Step 1403, an optical recording medium is fabricated from the stamper by replication.

In Step 1404, disk identification information, layer identification information 112 and wobble signals 1301, 1302 are recorded in the fabricated optical recording medium. (Used is a control apparatus for an optical recording medium capable of recording wobble signals 1301, 1302.) The control apparatus for an optical recording medium used in Step 1404 is described later. The fabricated optical recording medium is shipped.

The fabricated optical recording medium is delivered to a dubbing company or a user. In Step 1405, the dubbing company records contents (such as a movie) in the optical recording medium. The optical recording medium with the contents recorded is on sale to a user.

A user purchases an optical recording medium with nothing recorded in the data recording region or an optical recording medium with contents or the like recorded, and then records into or reproduces or from the optical recording medium, using a control apparatus for an optical recording medium. The control apparatus for an optical recording medium used by the user or the dubbing company is described later.

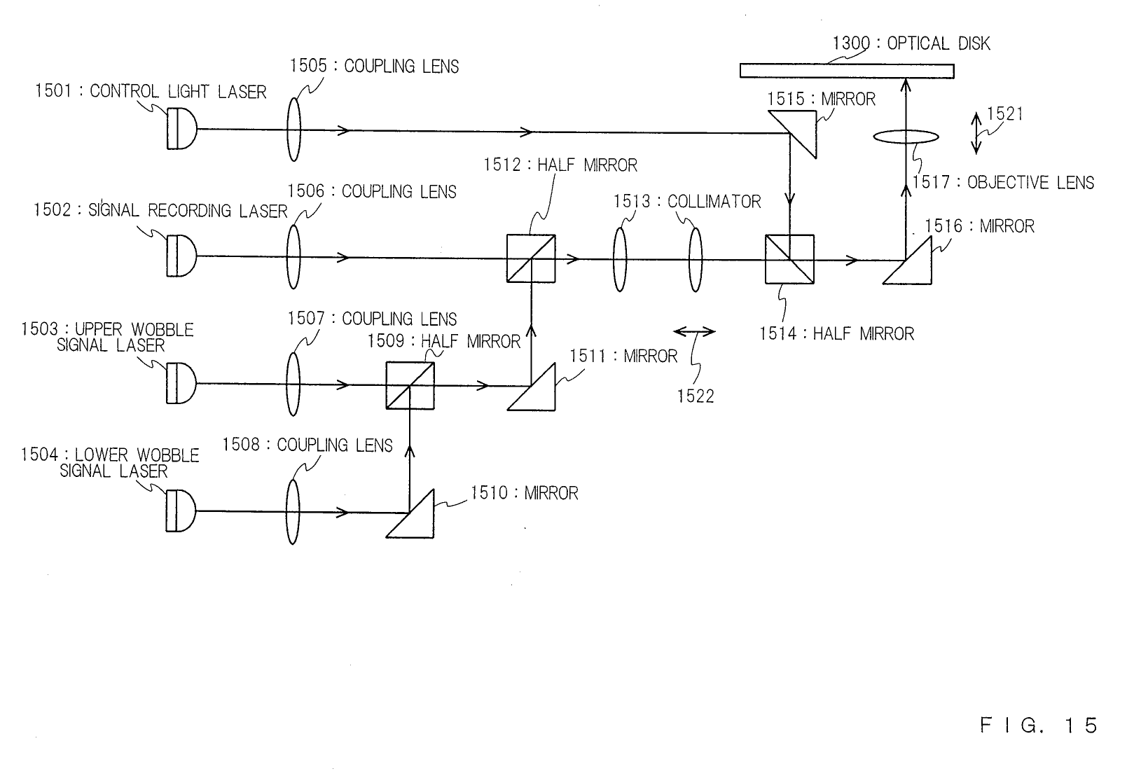

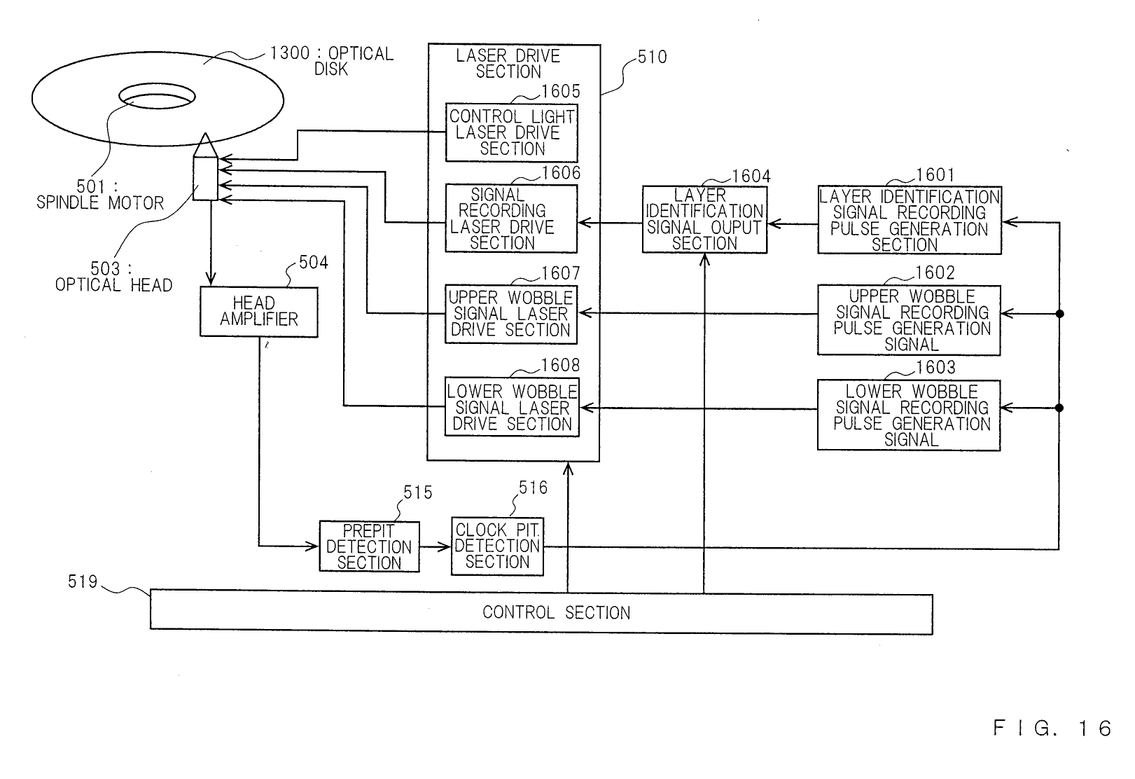

An optical pickup apparatus and a control apparatus for an optical recording medium according to Embodiment 7 capable of recording wobble signals 1301, 1302 (such as an apparatus used by an optical recording medium manufacturer in Step 1404) are described below with reference to FIGS. 15 and 16.

FIG. 15 is a schematic configuration diagram of an optical pickup apparatus of a control apparatus for an optical recording medium according to Embodiment 7. (Omitted is the optical system for the side beams and the reproduction system.) The optical pickup apparatus according to Embodiment 7 comprises a red laser (wavelength of 660 nm) 1501 and three blue lasers (wavelength of 405 nm) 1502-1504 (all are semiconductor lasers). In FIG. 15, numeral 1501 indicates a control light laser (red laser); numeral 1502 indicates a signal recording laser (blue laser); numeral 1503 indicates an upper wobble signal laser (blue laser); numeral 1504 indicates a lower wobble signal laser (blue laser); numerals 1505-1508 indicate coupling lenses; numerals 1510, 1511, 1515, 1516 indicate mirrors; numerals 1509, 1512, 1514 indicate half-mirrors; numeral 1513 indicates a collimator composed of two lenses; and numeral 1517 indicates an objective lens.

The light emitted from the upper wobble signal laser 1503 is formed into light slightly deviated from a substantial parallel beam state, by the coupling lens 1507. The imaging point of the light emitted from the upper wobble signal laser 1503 formed by the objective lens 1517 is slightly (by the distance wobbled upward) farther from the objective lens 1517 than the imaging point of the light emitted from the signal recording laser 1502. The light emitted from the upper wobble signal laser 1503 goes through the coupling lens 1507, and then goes into the half-mirror 1509.

The light emitted from the lower wobble signal laser 1504 is formed into light slightly deviated from a substantial parallel beam state, by the coupling lens 1508. The imaging point of the light emitted from the lower wobble signal laser 1504 formed by the objective lens 1517 is slightly (by the distance wobbled downward) nearer to the objective lens 1517 than the imaging point of the light emitted from the signal recording laser 1502. The light emitted from the lower wobble signal laser 1504 goes through the coupling lens 1508 and the mirror 1510, and then goes into the half-mirror 1509.

The half-mirror 1509 combines the light emitted from the laser 1503 and the light emitted from the laser 1504 such as to share an optical axis. The combined two light beams go through the mirror 1511, and then go into the half-mirror 1512.

The light emitted from the signal recording laser 1502 is substantially parallelized by the coupling lens 1506, and then combined with the light emitted from the lasers 1503, 1504 such as to share an optical axis, by the half-mirror 1512. The combined three light beams go through the collimator 1513 composed of two lenses, then go into the half-mirror 1514, and then are combined with the light emitted from the control light laser 1501 such as to share an optical axis.

The second focus adjustment section 506 can move one lens of the collimator 1513 in the optical path directions (directions 1522).

The light emitted from the control light laser 1501 is substantially parallelized by the coupling lens 1505, then passes the mirror 1515, and then is combined with the other light (emitted from the lasers 1502-1504) such as to share an optical axis, by the half-mirror 1514. The combined four light beams pass the mirror 1516, and then are focused respectively on four different points on the same optical axis in the optical recording medium 1300 by the objective lens 1517.

The light from the control light laser is separated into a main beam composed of zeroth-order diffraction light and side beams composed of positive and negative first-order diffraction light, by a reflection grating (not shown). The side beams are projected onto boundary portions between the groove 110 and the lands 111; the returned light thereof is used for tracking control. FIG. 15 depicts the main beam solely of the control light laser.

The reflectivities of the half-mirrors 1509, 1512, 1514 are selected depending on the desired light intensity ratios of the four light beams obtained in the optical recording medium 1300.

The light from the semiconductor lasers generally has an elliptical spot shape. After the light is substantially parallelized by the coupling lenses 1505-1508, means (such as a prism) may be provided for converting the spot shape of the light from the semiconductor lasers 1501-1504 into a substantially circular shape.

The optical pickup apparatus comprises: a first focus adjustment section (505 in FIG. 5) for moving the objective lens 1517 in the optical axis directions (directions indicated by numeral 1521); and a second focus adjustment section (506 in FIG. 5) for moving one lens of the collimator 1513 in the directions indicated by numeral 1522.

When the first focus adjustment section moves the objective lens 1517, the four focuses (imaging points) of the light beams from the lasers 1501-1504 move; in contrast, when the second focus adjustment section moves one lens of the collimator 1513, the three focuses (imaging points) of the light beams (other than the control light) from the lasers 1502-1504 move.

The first focus adjustment section automatically adjusts such that the control light (emitted from the control light laser 1501) is focused on the control track 103 (focus control, for example, by astigmatism method or spot size detection method). The tracking control section 507 (FIG. 5) carries out tracking control such as to equalize the amounts of the returned light from the side beams.

The second focus adjustment section moves one lens of the collimator 1513 discretely in the optical path directions (directions 1522), and thereby changes the imaging point difference between the control light (emitted from the control light laser 1501) and the recording and reproduction light (emitted from the signal recording laser 1502) discretely by the unit of a predetermined distance (the pitch between two recording tracks adjacent in the elevation directions, assumed to be a predetermined pitch according to a standard). This permits the focus of the recording and reproduction light to move accurately between the up and down recording layers 202. When the second focus adjustment section moves one lens of the collimator 1513, the imaging point of the light emitted from the upper wobble signal laser 1503 and the imaging point of the light emitted from the lower wobble signal laser 1504 are in linkage with the imaging point of the light emitted from the signal recording laser 1502, in a state displaced up and down respectively by a predetermined distance from the imaging point of the light emitted from the signal recording laser 1502. Thus, the recording apparatus can record the upper and lower wobble signals 1301, 1302 accurately in the optical recording medium.

During the recording or reproducing of a signal onto or from the recording track 112 of a recording layer 202, the second focus adjustment section normally does not move the lens of the collimator 1513. In the recording or reproducing, the focus of the recording and reproduction light is located on the same optical axis as the focus of the control light, and they are in linkage with each other; further, even in case that the optical disk has warpage, the distance from the control track 103 (control layer) of the optical disk to the imaging point of the recording and reproduction light does not change; accordingly, the imaging point of the recording and reproduction light is located correctly above the control track 103. Thus, the recording and reproduction light accurately records or reproduces a signal onto or from the recording track 104. Further, the wobble signals are recorded at positions displaced from the recording track 104 by a predetermined distance.

In reproduction, the optical pickup apparatus drives the control light laser 1501 and the signal recording laser 1502 solely. Since each laser has a wavelength different from each other, the returned light is easily separated, for example, using a dichroic filter.

FIG. 16 is a schematic configuration diagram of a control apparatus for an optical recording medium according to Embodiment 7 (apparatus for recording wobble signals). (Illustrated mainly are blocks for recording. The control system thereof and the like are the same as that in the control apparatus for an optical recording medium according to Embodiment 1 shown in FIG. 5, and hence the description is omitted.) In FIG. 16, like blocks to FIG. 5 are designated by like numerals. The description of the like blocks to FIG. 5 is omitted.

In FIG. 16, numeral 1300 indicates an optical disk; numeral 501 indicates a spindle motor; numeral 503 indicates an optical head; numeral 504 indicates a head amplifier; numeral 510 indicates a laser drive section; numeral 515 indicates a prepit detection section; numeral 516 indicates a clock pit detection section; numeral 519 indicates a control section; numeral 1601 indicates a layer identification signal recording pulse generation section; numeral 1602 indicates an upper wobble signal recording pulse generation section; numeral 1603 indicates a lower wobble signal recording pulse generation section; and numeral 1604 indicates a layer identification signal output section.

The laser drive section 510 comprises a control light laser drive section 1605, a signal recording laser drive section 1606, an upper wobble signal laser drive section 1607 and a lower wobble signal laser drive section 1608.

The prepit detection section 515 extracts prepit signals from the output signal of the head amplifier 504. The clock pit detection section 516 receives the prepit signals, and thereby outputs a clock pit signal.

The layer identification signal recording pulse generation section 1601, the upper wobble signal recording pulse generation section 1602 and the lower wobble signal recording pulse generation section 1603 output a layer identification signal recording pulse, an upper wobble signal recording pulse and a lower wobble signal recording pulse, respectively, each of which is a pulse delayed by a respective predetermined time from the clock pit signal. Each time delay is determined depending on the relative distance between the clock pit 108 and each signal shown in FIG. 13(b) and the linear speed of the optical disk.

The layer identification signal output section 1604 receives a layer identification signal to be recorded, from the control section 519, and thereby outputs the layer identification signal, one bit by one bit (0 or 1), in response to the layer identification signal recording pulse.

The laser drive section 510 operates in response to an instruction from the control section 519.

The control light laser drive section 1605 drives the control light laser 1501 at a predetermined light emitting power.

The signal recording laser drive section 1606 supplies an electric current to the signal recording laser 1502 in response to the layer identification signal recording pulse, and thereby records the layer identification signal (0 or 1). (When the layer identification signal is 0, a space signal is recorded; in contrast, when the layer identification signal is 1, a mark signal is recorded.) In the present embodiment, the signal recording laser 1502 records solely the layer identification signal, but may record any other information.

In response to the upper wobble signal recording pulse and the lower wobble signal recording pulse, the upper wobble signal laser drive section 1607 and the lower wobble signal laser drive section 1608 supply electric currents to the upper wobble signal laser 1503 and the lower wobble signal laser 1504, respectively, and thereby record one-bit wobble signals (mark signals where the optical property of the photosensitive material is changed).

In reproduction, the control light laser drive section 1605 and the signal recording laser drive section 1606 are driven solely. The operation thereof is the same as the above-mentioned embodiments.

Described below is an control apparatus for an optical recording medium according to Embodiment 7 (apparatus for reproducing wobble signals and thereby carrying out focus control). The control apparatus for an optical recording medium according to Embodiment 7 has the same basic configuration as the control apparatus for an optical recording medium according to Embodiment 1 (FIG. 5). The only difference of the control apparatus for an optical recording medium according to Embodiment 7 from that of Embodiment 1 is the internal configuration of the second focus adjustment section 506.

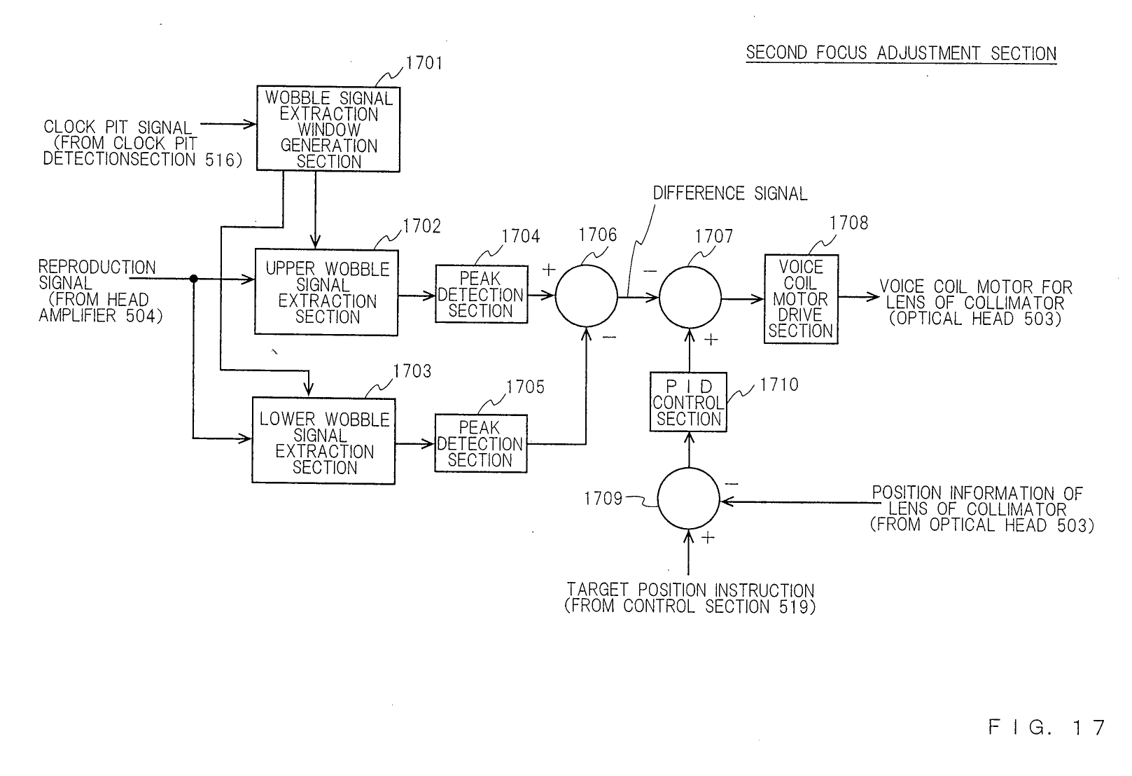

FIG. 17 is a schematic configuration diagram of the second focus adjustment section of a control apparatus for an optical recording medium according to Embodiment 7 (apparatus for reproducing wobble signals and thereby carrying out focus control).

In FIG. 17, numeral 1701 indicates a wobble signal extraction window generation section; numeral 1702 indicates an upper wobble signal extraction section; numeral 1703 indicates a lower wobble signal extraction section; numerals 1704, 1705 indicate peak detection sections; numerals 1706, 1707, 1709 indicate subtractors; numeral 1708 indicates a voice coil motor drive section; and numeral 1710 indicates a PID control section (a prior art control circuit using proportion, integration and differentiation).

The second focus adjustment section according to Embodiment 1 and the like comprises the subtractor 1709, the PID control section 1710 and the voice coil motor drive section 1708. The second focus adjustment section according to Embodiment 7 is characterized by the blocks 1701-1707.

The wobble signal extraction window generation section 1701 generates an upper wobble signal extraction window signal and a lower wobble signal extraction window signal each delayed by a respective predetermined time from the inputted clock pit signal (outputted from the clock pit detection section 516), and then transmits the signals to the upper wobble signal extraction section 1702 and the lower wobble signal extraction section 1703, respectively. Each time delay is determined depending on the relative distance between the clock pit 108 and each signal shown in FIG. 13(b) and the linear speed of the optical disk.

The upper wobble signal extraction section 1702 receives a reproduction signal (outputted from the head amplifier 504), and thereby outputs the signal during the time when the upper wobble signal extraction window signal is at high level. The peak detection section 1704 detects the maximum peak level during the time when the upper wobble signal extraction window signal is at high level; then, the peak detection section 1704 holds and outputs the level.

The lower wobble signal extraction section 1703 receives a reproduction signal (outputted from the head amplifier 504), and thereby outputs the signal during the time when the lower wobble signal extraction window signal is at high level. The peak detection section 1705 detects the maximum peak level during the time when the lower wobble signal extraction window signal is at high level; then, the peak detection section 1705 holds and outputs the level.

The subtractor 1706 subtracts the output signal of the peak detection section 1705 from the output signal of the peak detection section 1704, and thereby outputs the difference signal. When the focus of the recording and reproduction light is located at the center (in the up and down directions) of the recording track, the difference signal is substantially zero. In the present embodiment, when the focus of the recording and reproduction light is located above the center of the recording tracks, the difference signal has a positive value. In contrast, when the focus of the recording and reproduction light is located below the center of the recording tracks, the difference signal has a negative value. In case that the peak detection sections 1704, 1705 detect minimum peak levels, the situation is reversed.

The subtractor 1709 subtracts the position information of the lens of the collimator 304 (outputted from the position sensor for detecting the position of the lens of the collimator) from the target position instruction transmitted from the control section 519, and thereby output the subtraction result.

The PID control section 1710 receives the subtraction result, thereby performs prior art proportion, integration and differentiation operations, and then outputs the operation result. The subtractor 1707 subtracts the difference signal (output signal from the subtractor 1706) from the output signal of the PID control section 1710, and thereby outputs the subtraction result. The voice coil motor drive section 1708 supplies an electric current proportional to the subtraction result outputted from the subtractor 1707, to a voice coil motor (in the optical head 503) for driving the collimator lens.

In the second focus adjustment section according to Embodiment 1 and the like comprising the subtractor 1709, the PID control section 1710 and the voice coil motor drive section 1708, the recording position of the recording track can suffer certain variation. In the second focus adjustment section according to Embodiment 7, when the difference signal (output signal from the subtractor 1706) has a positive value, the lens of the collimator is moved such as to reduce the focal length of the recording and reproduction light (such as to lower the focus position); in contrast, when the difference signal (output signal from the subtractor 1706) has a negative value, the lens of the collimator is moved such as to increase the focal length of the recording and reproduction light (such as to raise the focus position). As such, the recording and reproduction light is focused accurately on the center (in the up and down directions) of the recording track.

### Embodiment 8

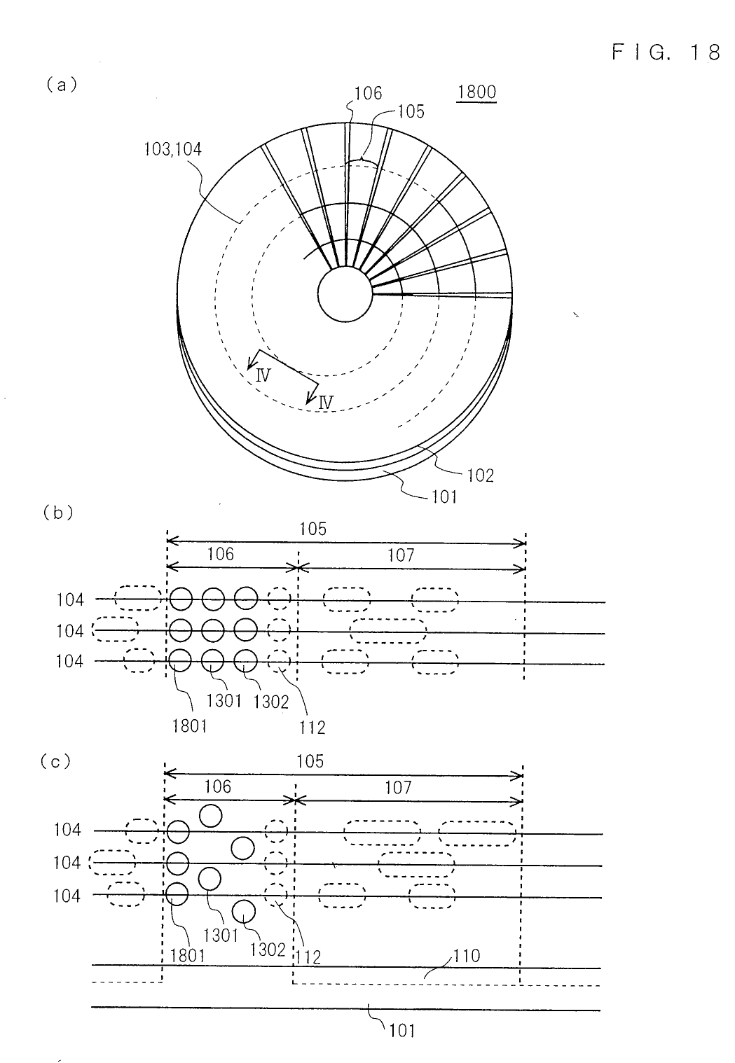

An optical recording medium according to Embodiment 8 is described below with reference to FIG. 18. The optical recording medium according to Embodiment 8 is an optical disk for recording information in three dimensions in a photosensitive material.

FIG. 18(a) is a schematic general configuration diagram of an optical disk 1800 according to Embodiment 8. FIG. 18(a) is the same as FIG. 13(a), and hence the description is omitted.

The schematic enlarged view of a segment 105 of a control track 103 is the same as shown in FIG. 1(b), and hence the drawing and the description are omitted.

FIG. 18(b) is a schematic enlarged view of a segment 105 of a recording track 104 (the optical disk is viewed from the above). FIG. 18(c) is a schematic cross sectional view of the optical recording medium according to Embodiment 8 of the invention, taken along line IV-IV of FIG. 18(a) (along a plane parallel to the recording track 104).

In FIG. 18(b), the segment 105 comprises: a servo region 106; and a data recording region 114 having a length 107. The servo region 106 records: a clock signal 1800; wobble signals 1301, 1302 wobbled up and down (in the thickness directions of the photosensitive material); and a layer identification signal 112.

In comparison with Embodiment 7, in the optical recording medium according to Embodiment 8, the distance between the up and down recording tracks is smaller; and a wobble signal is shared by two recording tracks surrounding the wobble signal from the up and down. Thus, the up and down positions of the wobble signals are reversed in the odd-numbered recording layer and the even-numbered recording layer.

The other points are the same in the two optical recording media according to Embodiments 7 and 8.

The second focus adjustment section 506 reverses the polarity of the output signal of the subtractor 1706 (FIG. 17) on the basis of the layer identification number. The other points are the same in the two control apparatuses according to Embodiments 7 and 8.

Further, recorded is a clock signal 1801 serving similarly as the clock pit 108. The other points are the same in the two embodiments. The control apparatus for an optical recording medium may read out the wobble signals 1301, 1302, using the reproduction signal of the clock pit 108, or alternatively, may read out the wobble signals 1301, 1302, using the reproduction signal of the clock signal 1801.

The other points are the same in the two optical recording media according to Embodiments 7 and 8.

### Embodiment 9

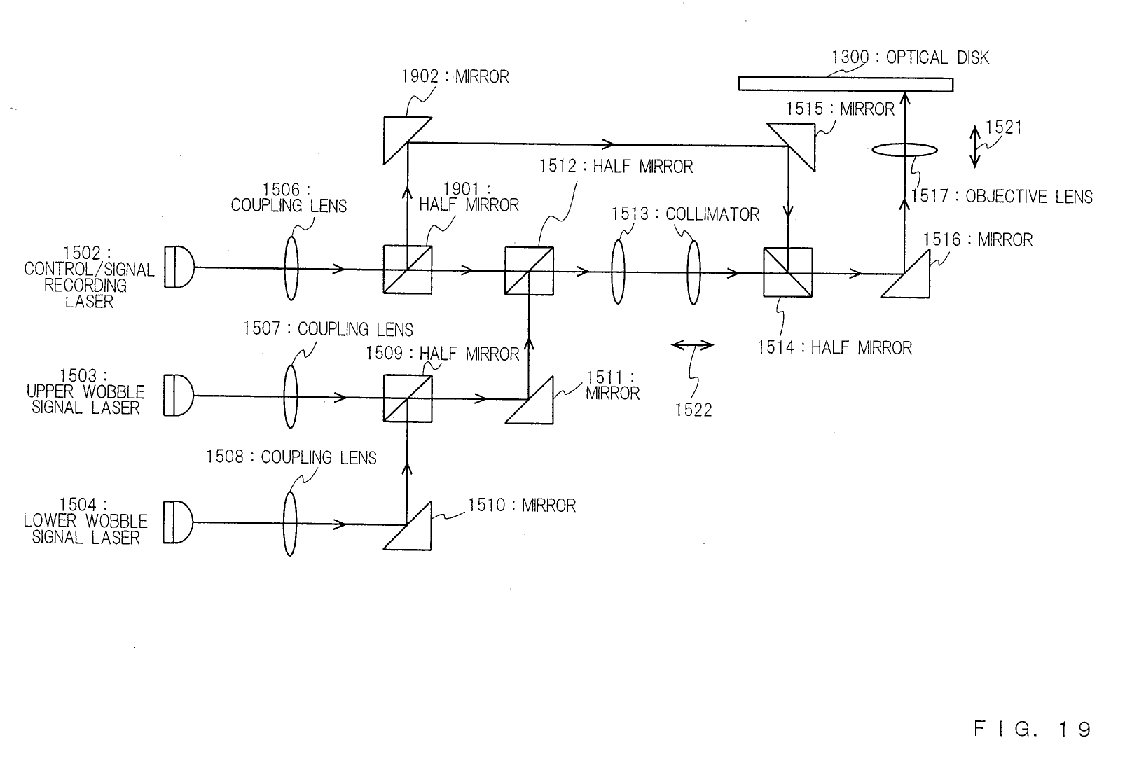

An optical pickup apparatus according to Embodiment 9 of the invention is described below with reference to FIG. 19. FIG. 19 is a schematic configuration diagram of an optical pickup apparatus according to Embodiment 9. (The recording optical system is depicted solely, and the description of the reproduction optical system is omitted.)

The optical pickup apparatus according to Embodiment 7 has comprised the control light laser 1501 and the coupling lens 1505 thereof. In place of these, the optical pickup apparatus according to Embodiment 9 comprises half-mirrors 1901, 1902. A part of the light emitted from the control/signal recording laser 1502 is separated by the half-mirror 1901, and thereby used as the control light. The other points are the same in the two embodiments.

### Embodiment 10

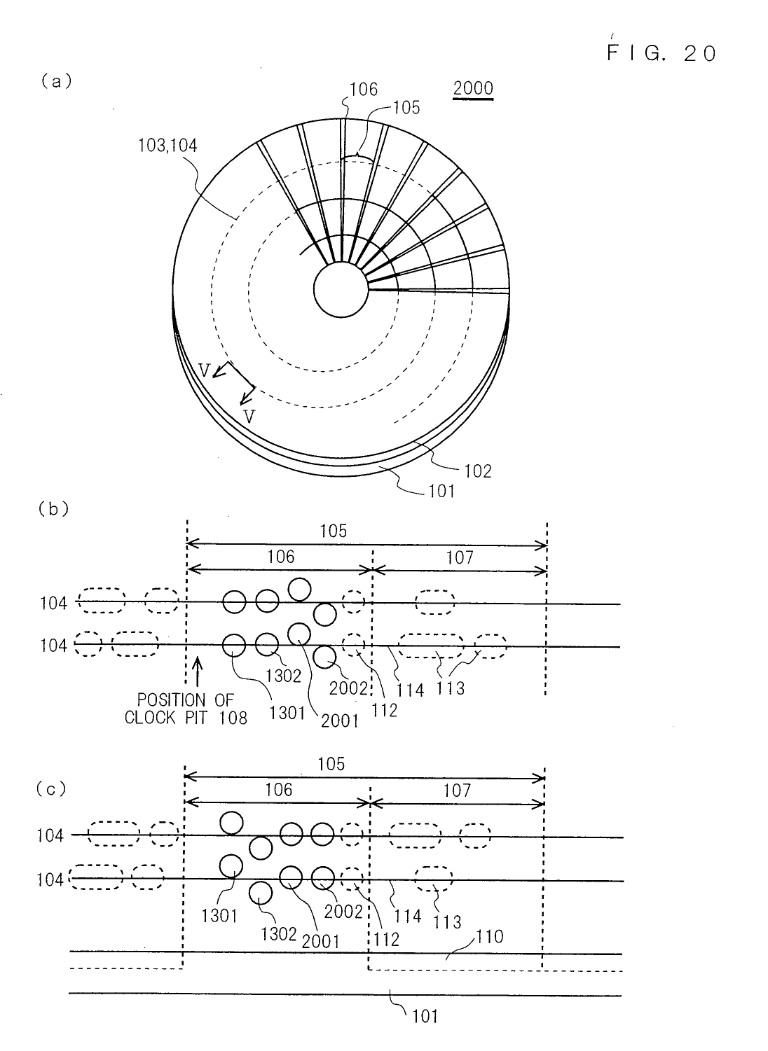

An optical recording medium, an optical pickup apparatus and a control apparatus for an optical recording medium according to Embodiment 10 are described below with reference to FIGS. 20-23.

An optical recording medium according to Embodiment 10 is described below with reference to FIG. 20. The optical recording medium according to Embodiment 10 is an optical disk for recording information in three dimensions in a photosensitive material.

FIG. 20(a) is a schematic general configuration diagram of the optical disk 2000 according to Embodiment 10. FIG. 20(a) is the same as FIG. 13(a), and hence the description is omitted.

The schematic enlarged view of a segment 105 of a control track 103 is the same as shown in FIG. 1(b), and hence the drawing and the description are omitted.

FIG. 20(b) is a schematic enlarged view of a segment 105 of a recording track 104 (the optical disk is viewed from the above). FIG. 20(c) is a schematic cross sectional view of the optical recording medium according to Embodiment 10 of the invention, taken along line V-V of FIG. 20(a) (along a plane parallel to the recording track 104).

In FIG. 20(b), the segment 105 comprises: a servo region 106; and a data recording region 114 having a length 107. The servo region 106 records: wobble signals 1301, 1302 wobbled up and down (in the thickness directions of the photosensitive material) from diverse positions along the recording track; wobble signals 2001, 2002 wobbled left and right (in certain positions displaced left and right from the recording track within the recording layer (at the same elevation)) from diverse positions along the recording track; and a layer identification signal 112.

In comparison with Embodiment 7, the optical recording medium according to Embodiment 10 is characterized by comprising not only the wobble signals 1301, 1302 wobbled in the up and down of the recording track, but also the wobble signals 2001, 2002 wobbled in the left and right of the recording track.

The other points are the same in the two optical recording media according to Embodiments 7 and 10.

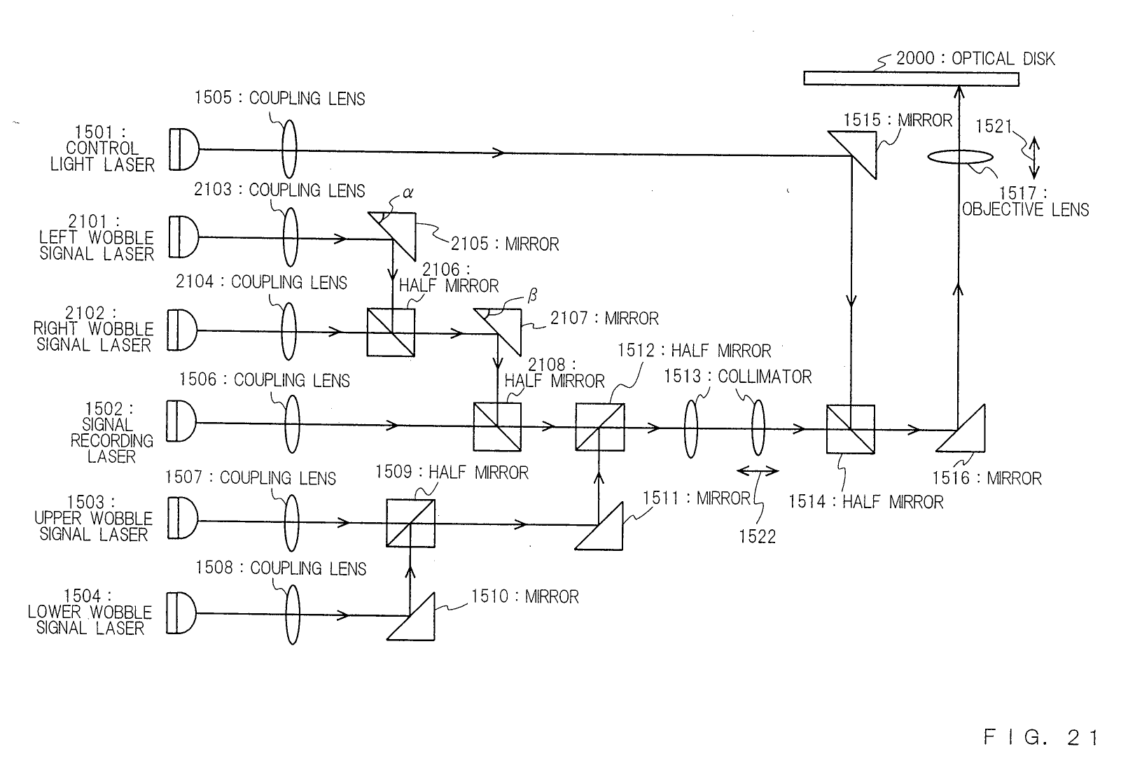

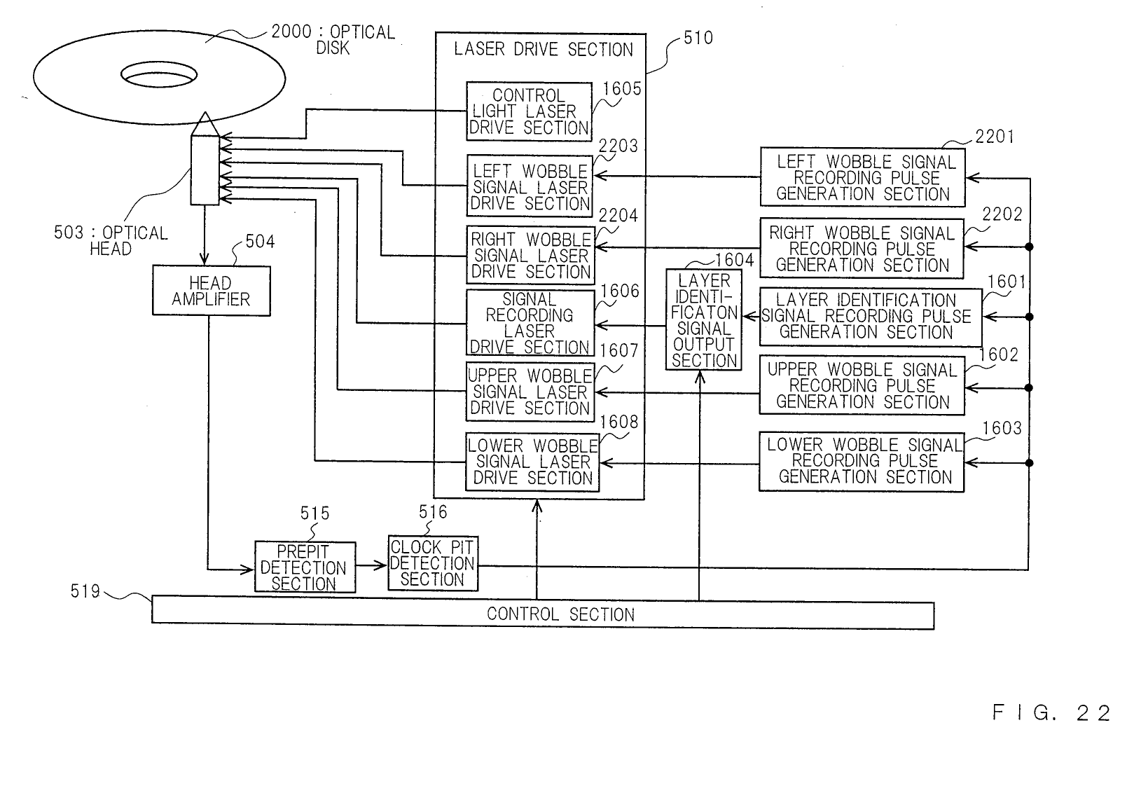

A control apparatus for an optical recording medium according to Embodiment 10 capable of recording wobble signals 1301, 1302, 2001, 2002 (such as an apparatus used by an optical recording medium manufacturer in Step 1404 (FIG. 14)) are described below with reference to FIGS. 21 and 22.

FIG. 21 is a schematic configuration diagram of an optical pickup apparatus according to Embodiment 10. (Omitted is the optical system for the side beams and the reproduction system.) In FIG. 21, like parts to FIG. 15 are designated by like numerals. The optical pickup apparatus according to Embodiment 10 comprises a red laser (wavelength of 660 nm) 1501 and five blue lasers (wavelength of 405 nm) 2102, 2102, 1502-1504 (all are semiconductor lasers). In FIG. 21, numeral 1501 indicates a control light laser (red laser); numeral 2101 indicates a left wobble signal laser (blue laser); numeral 2102 indicates a right wobble signal laser (blue laser); numeral 1502 indicates a signal recording laser (blue laser); numeral 1503 indicates an upper wobble signal laser (blue laser); numeral 1504 indicates a lower wobble signal laser (blue laser); numerals 1505-1508, 2103, 2104 indicate coupling lenses; numerals 1510, 1511, 1515, 1516, 2105, 2107 indicate mirrors; numerals 1509, 1512, 1514, 2106, 2108 indicate half-mirrors; numeral 1513 indicates a collimator composed of two lenses; and numeral 1517 indicates an objective lens.

The paths of the upper wobble signal laser 1503 and the lower wobble signal laser 1504 are the same as those of FIG. 15 (Embodiment 7), and hence the description is omitted.

The light emitted from the left wobble signal laser 2101 is substantially parallelized by the coupling lens 2103, then reflected in the mirror 2105, and then combined with the light emitted from the right wobble signal laser 2102, by the half-mirror 2106. The angle α of the mirror 2105 is slightly smaller than 45 degrees (that is, (45-ε) degrees); accordingly, the light from the left wobble signal laser 2101 is focused, by the objective lens 1517, on a position (recording position of the left wobble signal) displaced slightly leftward from the center (in the left and right directions) of the recording track. (This situation is a result considering also a rightward displacement by angle β of the mirror 2107 described later.)

The light emitted from the right wobble signal laser 2102 is substantially parallelized by the coupling lens 2104, and then combined with the light emitted from the left wobble signal laser 2101, by the half-mirror 2106. After that, the combined light is reflected in the mirror 2107, and then combined with the light emitted from the signal recording laser 1502, by the half-mirror 2108. The angle β of the mirror 2107 is slightly larger than 45 degrees (that is, (45+ε) degrees); accordingly, the light from the right wobble signal laser 2102 is focused, by the objective lens 1517, on a position (recording position of the right wobble signal) displaced slightly rightward from the center (in the left and right directions) of the recording track.

The light emitted from the signal recording laser 1502 is substantially parallelized by the coupling lens 1506, then combined with the light emitted from the lasers 2101, 2102, by the half-mirror 2108, and then combined with the light emitted from the lasers 1503, 1504 such as to share an optical axis, by the half-mirror 1512. The combined five light beams go through the collimator 1513 composed of two lenses, then go into the half-mirror 1514, and then are combined with the light emitted from the control light laser 1501 so that the light emitted from the control light laser 1501 and the light emitted from the signal recording laser 1502 share an optical axis.

The light emitted from the control light laser 1501 is substantially parallelized by the coupling lens 1505, then passes the mirror 1515, and then is combined with the other light (emitted from the lasers 1502-1504, 2101, 2102). The combined six light beams pass the mirror 1516, and then are focused respectively on four different positions on the same optical axis and on two positions displaced left and right slightly from the optical axis in the optical recording medium 2000 by the objective lens 1517.

The light from the control light laser is separated into a main beam composed of zeroth-order diffraction light and side beams composed of positive and negative first-order diffraction light, by a reflection grating (not shown). The side beams are projected onto boundary portions between the groove 110 and the lands 111; the returned light thereof is used for tracking control. FIG. 21 depicts the main beam solely of the control light laser.

The reflectivities of the half-mirrors 1509, 1512, 1514, 2106, 2108 are selected depending on the desired light intensity ratios of the six light beams obtained in the optical recording medium 2000.

The light from the semiconductor lasers generally has an elliptical spot shape. After the light is substantially parallelized by the coupling lenses, means (such as a prism) may be provided for converting the spot shape of the light from the semiconductor lasers into a substantially circular shape.

The optical pickup apparatus comprises: a first focus adjustment section (505 in FIG. 5) for moving the objective lens 1517 in the optical axis directions (directions indicated by numeral 1521); and a second focus adjustment section (506 in FIG. 5) for moving one lens of the collimator 1513 in the directions indicated by numeral 1522.

When the first focus adjustment section moves the objective lens 1517, the six focuses (imaging points) of the light beams from the lasers 1501-1504, 2101, 2102 move; in contrast, when the second focus adjustment section moves one lens of the collimator 1513, the five focuses (imaging points) of the light beams (other than the control light) from the lasers 1502-1504, 2101, 2102 move.

The first focus adjustment section automatically adjusts such that the control light (emitted from the control light laser 1501) is focused on the control track 103 (focus control, for example, by astigmatism method or spot size detection method). The tracking control section 507 (FIG. 5) carries out tracking control such as to equalize the amounts of the returned light from the side beams.

The second focus adjustment section moves one lens of the collimator 1513 discretely in the optical path directions (directions 1522), and thereby changes the imaging point difference between the control light (emitted from the control light laser 1501) and the recording and reproduction light (emitted from the signal recording laser 1502) discretely by the unit of a predetermined distance (the pitch between two recording tracks adjacent in the elevation directions, assumed to be a predetermined pitch according to a standard). This permits the focus of the recording and reproduction light to move accurately between the up and down recording layers 202. When the second focus adjustment section moves one lens of the collimator 1513, the imaging point of the light emitted from the upper wobble signal laser 1503 and the imaging point of the light emitted from the lower wobble signal laser 1504 are in linkage with the imaging point of the light emitted from the signal recording laser 1502, in a state displaced up and down respectively by a predetermined distance from the imaging point of the light emitted from the signal recording laser 1502. Thus, the recording apparatus can record the upper and lower wobble signals 1301, 1302 accurately in the optical recording medium.

When the second focus adjustment section moves one lens of the collimator 1513, the imaging point of the light emitted from the left wobble signal laser 2101 and the imaging point of the light emitted from the right wobble signal laser 2102 are in linkage with the imaging point of the light emitted from the signal recording laser 1502, in a state displaced left and right (the elevations of the focuses are the same as the imaging point of the signal recording laser 1502) respectively by a predetermined distance from the imaging point of the light emitted from the signal recording laser 1502. Thus, the recording apparatus can record the left and right wobble signals 2001, 2002 accurately in the optical recording medium.

FIG. 22 is a schematic configuration diagram of a control apparatus for an optical recording medium according to Embodiment 10 (apparatus for recording wobble signals). (Illustrated mainly are blocks for recording. The control system thereof and the like are the same as that in the control apparatus for an optical recording medium according to Embodiment 1 shown in FIG. 5, and hence the description is omitted.) In FIG. 22, like blocks to FIGS. 5 are 16 designated by like numerals. The description of the like blocks to FIG. 5 is omitted.

In FIG. 22, numeral 2000 indicates an optical disk; numeral 501 indicates a spindle motor; numeral 503 indicates an optical head; numeral 504 indicates a head amplifier; numeral 510 indicates a laser drive section; numeral 515 indicates a prepit detection section; numeral 516 indicates a clock pit detection section; numeral 519 indicates a control section; numeral 2201 indicates a left wobble signal recording pulse generation section; numeral 2202 indicates a right wobble signal recording pulse generation section; numeral 1601 indicates a layer identification signal recording pulse generation section; numeral 1602 indicates an upper wobble signal recording pulse generation section; numeral 1603 indicates a lower wobble signal recording pulse generation section; and numeral 1604 indicates a layer identification signal output section.

The laser drive section 510 comprises a control light laser drive section 1605, a left wobble signal laser drive section 2203, a right wobble signal laser drive section 2204, a signal recording laser drive section 1606, an upper wobble signal laser drive section 1607 and a lower wobble signal laser drive section 1608.

The prepit detection section 515 extracts prepit signals from the output signal of the head amplifier 504. The clock pit detection section 516 receives the prepit signals, and thereby outputs a clock pit signal (reproduction signal of the clock pit 108).

The left wobble signal recording pulse generation section 2201, the right wobble signal recording pulse generation section 2202, the layer identification signal recording pulse generation section 1601, the upper wobble signal recording pulse generation section 1602 and the lower wobble signal recording pulse generation section 1603 output a left wobble signal recording pulse, a right wobble signal recording pulse, a layer identification signal recording pulse, an upper wobble signal recording pulse and a lower wobble signal recording pulse, respectively, each of which is a pulse delayed by a respective predetermined time from the clock pit signal. Each time delay is determined depending on the relative distance between the clock pit 108 and each signal shown in FIG. 20(b) and the linear speed of the optical disk.

The layer identification signal output section 1604 receives a layer identification signal to be recorded, from the control section 519, and thereby outputs the layer identification signal, one bit by one bit (0 or 1), in response to the layer identification signal recording pulse.

The laser drive section 510 operates in response to an instruction from the control section 519.

The control light laser drive section 1605 drives the control light laser 1501 at a predetermined light emitting power.

The signal recording laser drive section 1606 supplies an electric current to the signal recording laser 1502 in response to the layer identification signal recording pulse, and thereby records the layer identification signal (0 or 1). (When the layer identification signal is 0, a space signal is recorded; in contrast, when the layer identification signal is 1, a mark signal is recorded.) In the present embodiment, the signal recording laser 1502 records solely the layer identification signal, but may record any other information.

In response to the left wobble signal recording pulse and the right wobble signal recording pulse, the left wobble signal laser drive section 2203 and the right wobble signal laser drive section 2204 supply electric currents to the left wobble signal laser 2201 and the right wobble signal laser 2202, respectively, and thereby record one-bit wobble signals (mark signals where the optical property of the photosensitive material is changed).

In response to the upper wobble signal recording pulse and the lower wobble signal recording pulse, the upper wobble signal laser drive section 1607 and the lower wobble signal laser drive section 1608 supply electric currents to the upper wobble signal laser 1503 and the lower wobble signal laser 1504, respectively, and thereby record one-bit wobble signals (mark signals where the optical property of the photosensitive material is changed).

In reproduction, the control light laser drive section 1605 and the signal recording laser drive section 1606 are driven solely. The operation thereof is the same as the above-mentioned embodiments.

Described below is an control apparatus for an optical recording medium according to Embodiment 10 (apparatus for reproducing wobble signals and thereby carrying out focus control). The control apparatus for an optical recording medium according to Embodiment 10 has the same basic configuration as the control apparatus for an optical recording medium according to Embodiment 7 (FIG. 5). The only difference of the control apparatus for an optical recording medium according to Embodiment 10 from that of Embodiment 7 is the internal configuration of the tracking control section 507.

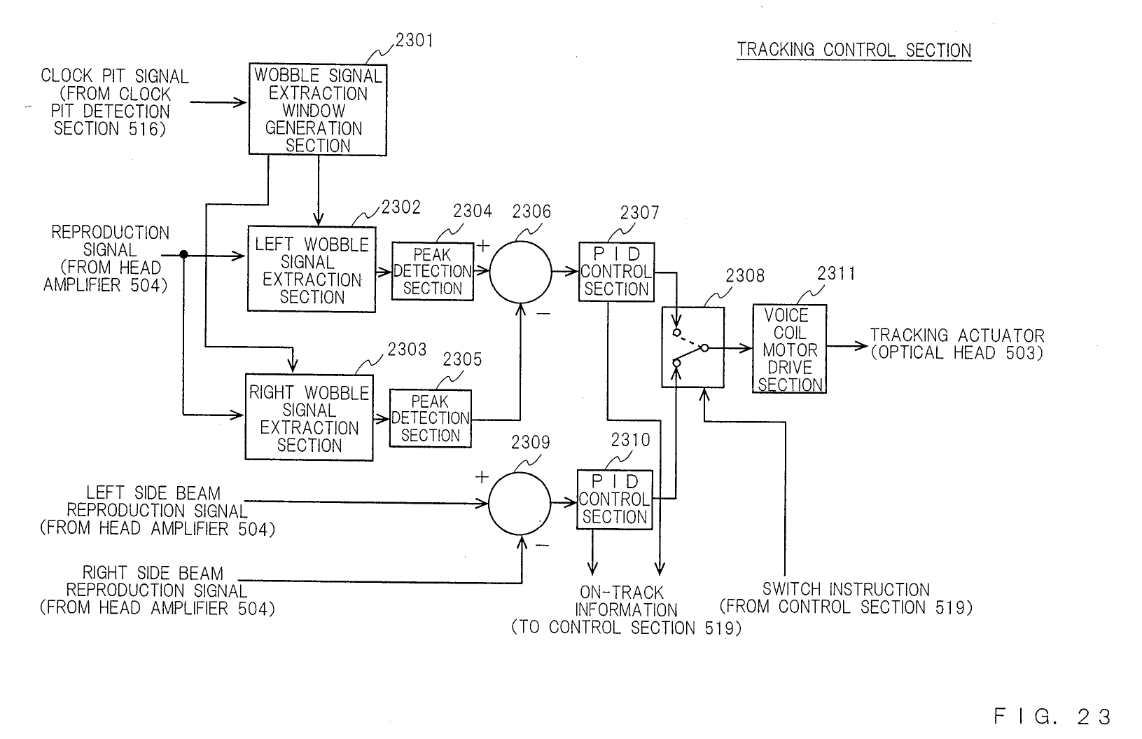

FIG. 23 is a schematic configuration diagram of the second focus adjustment section of a control apparatus for an optical recording medium according to Embodiment 10 (apparatus for reproducing wobble signals and thereby carrying out focus control).

In FIG. 23, numeral 2301 indicates a wobble signal extraction window generation section; numeral 2302 indicates a left wobble signal extraction section; numeral 2303 indicates a right wobble signal extraction section; numerals 2304, 2305 indicate peak detection sections; numerals 2306, 2309 indicate subtractors; numerals 2307, 2310 indicate PID control sections (a prior art control circuit using proportion, integration and differentiation); numeral 2308 indicates a switch; and numeral 2311 indicates a voice coil motor drive section.

The tracking control section 507 according to Embodiments 1, 7 and the like comprises the subtractor 2309, the PID control section 2310, and the voice coil motor drive section 2311. The tracking control section 507 according to Embodiment 10 is characterized by the blocks 2301-2308.

The wobble signal extraction window generation section 2301 generates a left wobble signal extraction window signal and a right wobble signal extraction window signal each delayed by a respective predetermined time from the inputted clock pit signal (outputted from the clock pit detection section 516), and then transmits the signals to the left wobble signal extraction section 2302 and the right wobble signal extraction section 2303, respectively. Each time delay is determined depending on the relative distance between the clock pit 108 and each signal shown in FIG. 20(b) and the linear speed of the optical disk.

The left wobble signal extraction section 2302 receives a reproduction signal (outputted from the head amplifier 504), and thereby outputs the signal during the time when the left wobble signal extraction window signal is at high level. The peak detection section 2304 detects the maximum peak level during the time when the left wobble signal extraction window signal is at high level; then, the peak detection section 2304 holds and outputs the level.

The right wobble signal extraction section 2303 receives a reproduction signal (outputted from the head amplifier 504), and thereby outputs the signal during the time when the right wobble signal extraction window signal is at high level. The peak detection section 2305 detects the maximum peak level during the time when the right wobble signal extraction window signal is at high level; then, the peak detection section 2305 holds and outputs the level.

The subtractor 2306 subtracts the output signal of the peak detection section 2305 from the output signal of the peak detection section 2304, and thereby outputs the difference signal. When the focus of the recording and reproduction light is located at the center (in the left and right directions) of the recording track, the difference signal is substantially zero. In the present embodiment, when the focus of the recording and reproduction light is located in the left of the center of the recording tracks, the difference signal has a positive value. In contrast, when the focus of the recording and reproduction light is located in the right of the center of the recording tracks, the difference signal has a negative value.

The PID control section 2307 receives the subtraction result, thereby performs prior art proportion, integration, and differentiation operations, and then outputs the operation result. When detecting that the absolute value of the output signal of the subtractor 2306 has reduced into a predetermined range, in the recording track, the PID control section 2307 transmits on-track information to the control section 519.

The subtractor 2309 subtracts the reproduction signal of the right side beam from the reproduction signal of the left side beam (both outputted from the head amplifier 504), and thereby outputs the subtraction result.

The PID control section 2310 receives the subtraction result, thereby performs prior art proportion, integration, and differentiation operations, and then outputs the operation result. When detecting the on-track state in the recording track, the PID control section 2310 transmits on-track information to the control section 519.

In response to an instruction from the control section 519, the switch 2308 selectively transmits the output signal of the PID control section either 2307 or 2310 to the voice coil motor drive section 2311.

The voice coil motor drive section 2311 supplies an electric current proportional to the input signal, to a tracking actuator (which is a voice coil motor in the optical head 503).

In the tracking control section according to Embodiment 10, when the output signal of the subtractor 2306 or 2309 has a positive value, the tracking actuator is driven such as to move the focus of the recording and reproduction light to the right; in contrast, when the output signal of the subtractor 2306 or 2309 has a negative value, the tracking actuator is driven such as to move the focus of the recording and reproduction light to the left. As such, the recording and reproduction light is focused accurately on the center (in the left and right directions) of the recording track.

When starting the control of the optical disk, the control section 519 first transmits an instruction to the switch 2308, and thereby causes the switch 2308 to transmit the output signal of the PID control section 2310 (control signal on the basis of the difference signal of the side beams from the control track) to the voice coil motor drive section 2311. When both PID control sections 2307, 2310 have transmitted on-track information (indicating that the control track is in the on-track state and that the absolute value of the output signal of the subtractor 2306 has reduced into a predetermined range, in the recording track) to the control section 519, the control section 519 transmits an instruction to the switch 2308. In response to the instruction, the switch 2308 switches from the PID control section 2310 into the PID control section 2307, and thereby transmits the output signal of the PID control section 2307 (control signal on the basis of the difference signal of the left and right wobble signals of the control track) to the voice coil motor drive section 2311.

Then, tracking control is carried out using the output signal of the PID control section 2307.

As such, the control apparatus for an optical recording medium according to Embodiment 10 can perform up and down and left and right tracking accurately.

### Embodiment 11

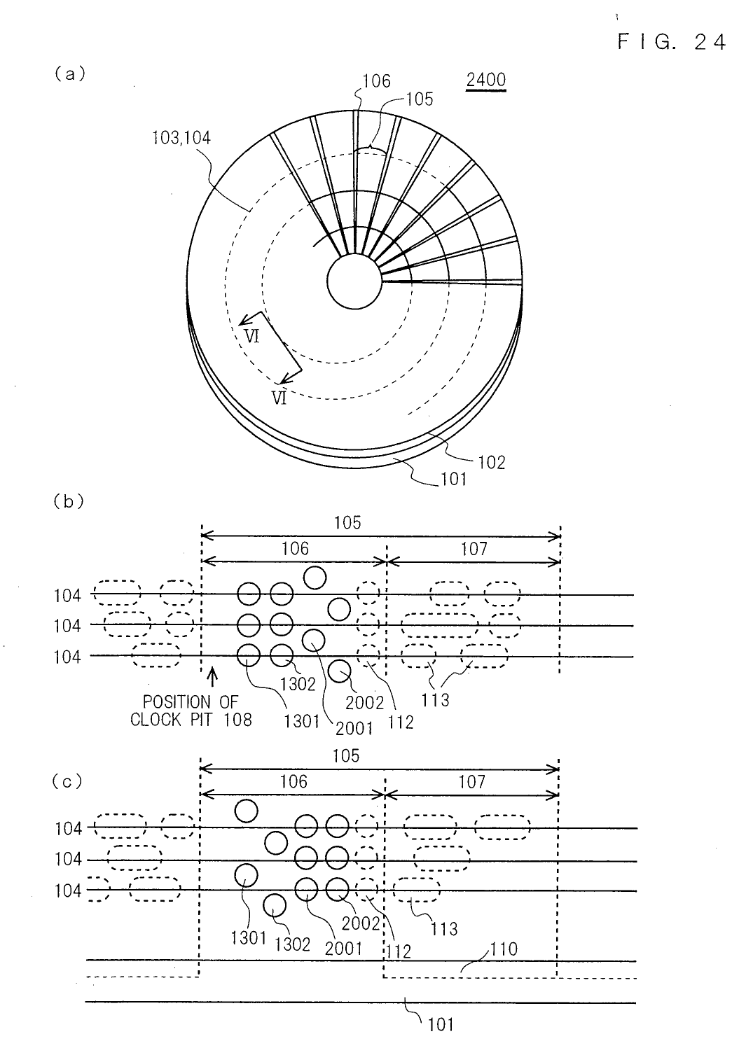

An optical recording medium according to Embodiment 11 is described below with reference to FIG. 24. The optical recording medium according to Embodiment 11 is an optical disk for recording information in three dimensions in a photosensitive material.

FIG. 24(a) is a schematic general configuration diagram of an optical disk 2400 according to Embodiment 11. FIG. 24(a) is the same as FIG. 20(a), and hence the description is omitted.

The schematic enlarged view of a segment 105 of a control track 103 is the same as shown in FIG. 1(b), and hence the drawing and the description are omitted.

FIG. 24(b) is a schematic enlarged view of a segment 105 of a recording track 104 (the optical disk is viewed from the above). FIG. 24(c) is a schematic cross sectional view of the optical recording medium according to Embodiment 11 of the invention, taken along line VI-VI of FIG. 24(a) (along a plane parallel to the recording track 104).

In FIG. 24(b), the segment 105 comprises: a servo region 106; and a data recording region 114 having a length 107. The servo region 106 records: wobble signals 1301, 1302 wobbled up and down (in the thickness directions of the photosensitive material) from diverse positions along the recording track; wobble signals 2001, 2002 wobbled left and right (in certain positions displaced left and right from the recording track within the recording layer (at the same elevation)) from diverse positions along the recording track; and a layer identification signal 112.

In comparison with Embodiment 10, in the optical recording medium according to Embodiment 11, the distances between the up and down and left and right recording tracks are smaller; and a wobble signal is shared by two recording tracks surrounding the wobble signal from the up and down; further, a wobble signal is shared by two recording tracks surrounding the wobble signal from the left and right. Thus, the left and right positions of the wobble signals are reversed in the odd-numbered recording track and the even-numbered recording track. The left and right positions of the wobble signals are reversed at the leading edge of a segment at a certain angle of the optical disk.

The up and down positions of the wobble signals are reversed in the odd-numbered recording layer and the even-numbered recording layer.

The other points are the same in the two optical recording media according to Embodiments 10 and 11.

The second focus adjustment section 506 reverses the polarity of the output signal of the subtractor 1706 (FIG. 17) on the basis of the layer identification number. Similarly, the tracking control section 507 reverses the polarity of the output signal of the subtractor 2306 (FIG. 23) at the position where the left and right positions of the wobble signals are reversed (at the leading edge of a segment at a certain angle of the optical disk). The other points are the same in the two control apparatuses according to Embodiments 10 and 11.

In the optical recording medium according to Embodiment 10 (FIG. 20), each recording track comprises dedicated (not shared with the other tracks) up and down and left and right wobble signals, while in the optical recording medium according to Embodiment 11 (FIG. 24), each recording track comprises up and down and left and right wobble signals shared with the adjacent tracks. In the optical recording medium according to another embodiment, each recording track comprises: dedicated up and down wobble signals; and left and right wobble signals shared with the adjacent tracks. In the optical recording medium according to further another embodiment, each recording track comprises: dedicated left and right wobble signals; and up and down wobble signals shared with the adjacent tracks. In these optical recording media, the same effect as the present embodiment is obtained.

### Embodiment 12

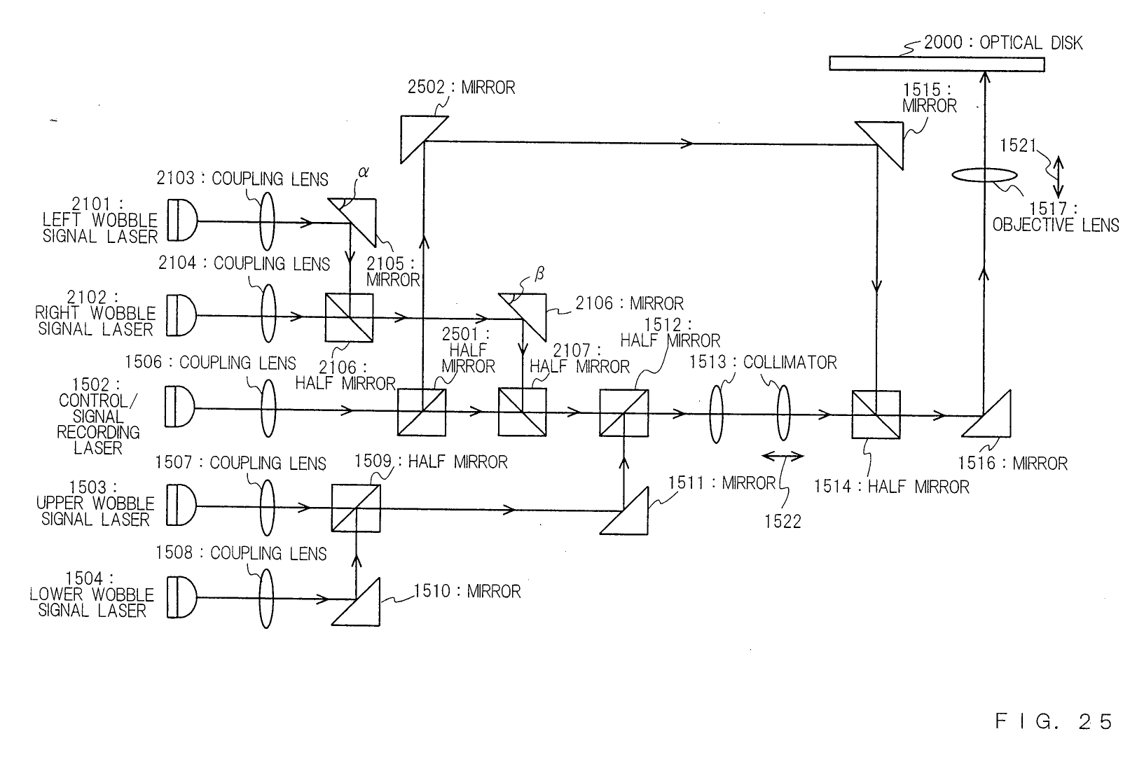

An optical pickup apparatus according to Embodiment 12 of the invention is described below with reference to FIG. 25. FIG. 25 is a schematic configuration diagram of an optical pickup apparatus according to Embodiment 12. (Omitted is the description of the system for the side beams and the reproduction system.)

The optical pickup apparatus according to Embodiment 10 has comprised the control light laser 1501 and the coupling lens 1505 thereof. In place of these, the optical pickup apparatus according to Embodiment 12 comprises half-mirrors 2501, 2502. A part of the light emitted from the control/signal recording laser 1502 is separated by the half-mirror 2501, and thereby used as the control light. The other points are the same in the two embodiments.

### Embodiment 13

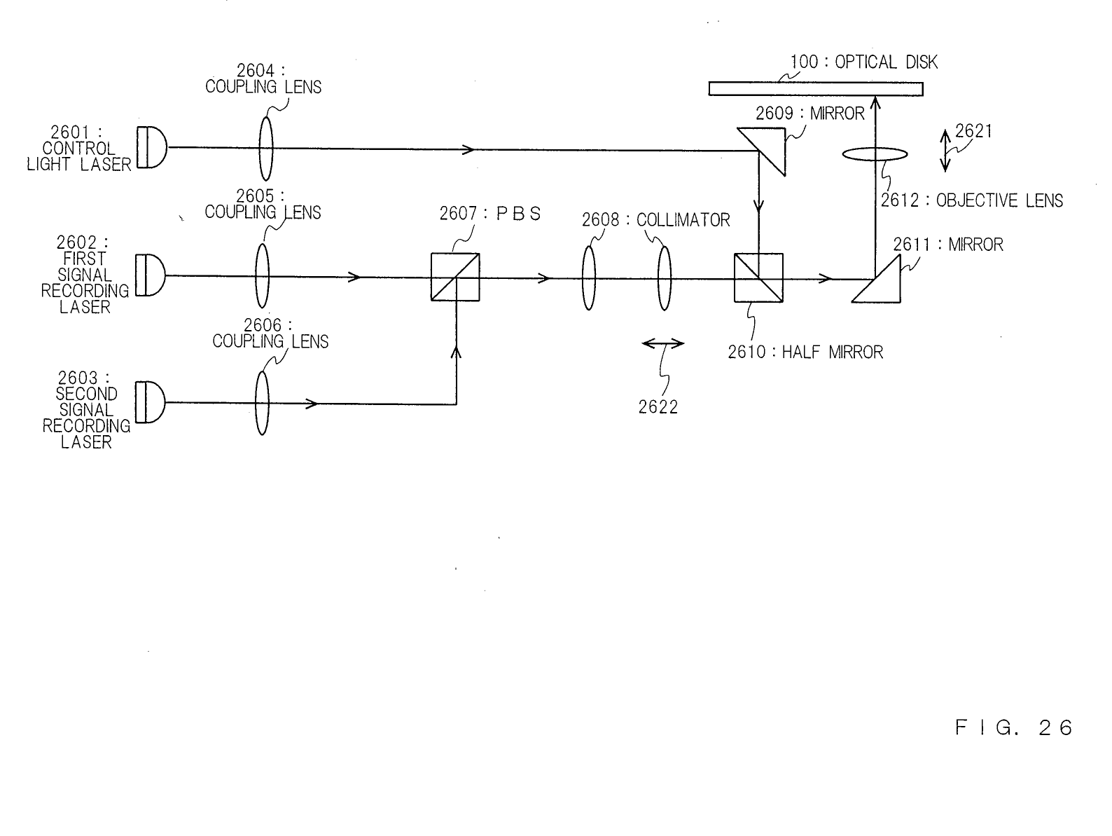

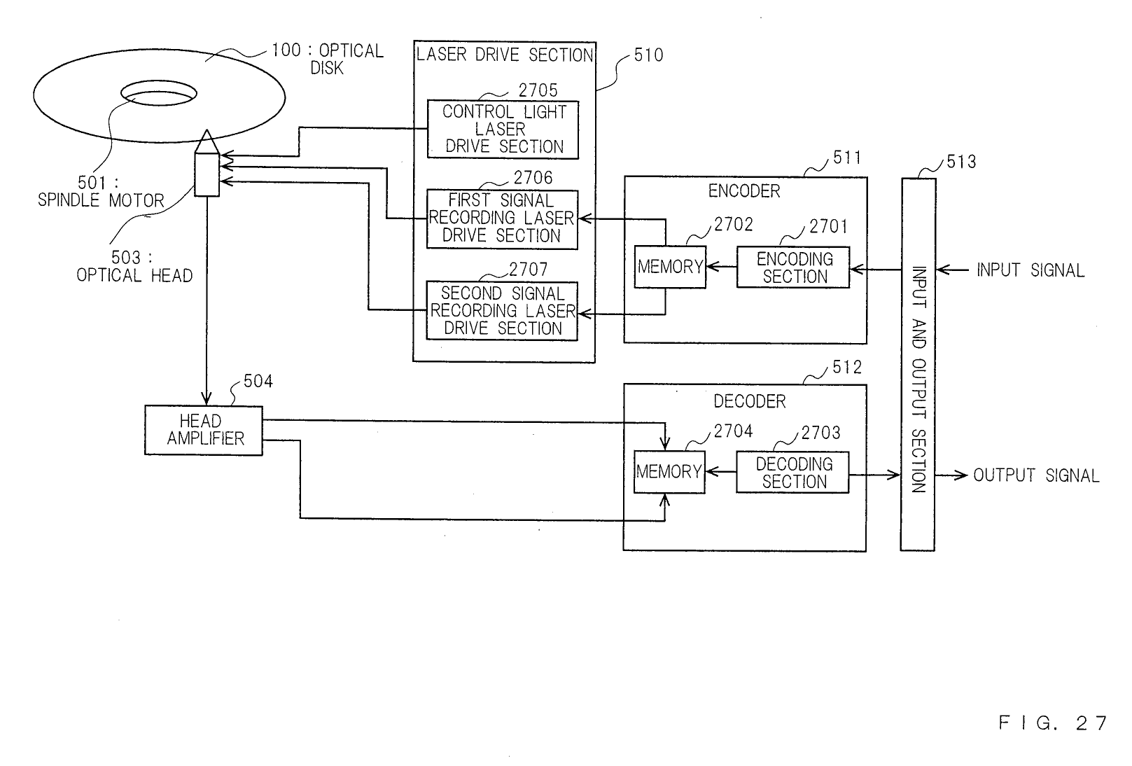

An optical pickup apparatus and a control apparatus for an optical recording medium according to Embodiment 13 are described below with reference to FIGS. 26 and 27.

The optical pickup apparatus according to Embodiment 13 is characterized by comprising a plurality (two, in Embodiment 13) of signal recording laser 2602, 2603 (used also for reproduction). By virtue of the use of the two signal recording lasers, the control apparatus for an optical recording medium according to Embodiment 13 can record, or reproduce and output, a signal at twice the transmission rate, in comparison with that of Embodiment 1 and the like.

The optical pickup apparatus and the control apparatus for an optical recording medium according to Embodiment 13 records or reproduces a signal into or from the optical recording medium according to Embodiment 1 (or another embodiment).

FIG. 26 is a schematic configuration diagram of an optical pickup apparatus of a control apparatus for an optical recording medium according to Embodiment 13. (Omitted is the optical system for the side beams and the reproduction system.) The optical pickup apparatus according to Embodiment 13 comprises a red laser (wavelength of 660 nm) 2601 and two blue lasers (wavelength of 405 nm) 2602 and 2603 (all are semiconductor lasers). In FIG. 26, numeral 2601 indicates a control light laser (red laser); numeral 2602 indicates a first signal recording laser (blue laser); numeral 2603 indicates a second signal recording laser (blue laser); numerals 2604-2606 indicate coupling lenses; numerals 2609 and 2611 indicate mirrors; numeral 2607 indicates a PBS; numeral 2610 indicates a half-mirror; numeral 2608 indicates a collimator composed of two lenses; and numeral 2612 indicates an objective lens.

The light emitted from the second signal recording laser 2603 is formed into light slightly deviated from a substantial parallel beam state, by the coupling lens 2612. The imaging point of the light emitted from the second signal recording laser 2603 formed by the objective lens 2612 is farther by an up-down pitch of the recording layers, from the objective lens 2612 than the imaging point of the light emitted from the first signal recording laser 2602. (The light from the second signal recording laser 2603 is focused on the upper recording track adjacent to the recording track on which the light from the first signal recording laser 2602 is focused.) The light emitted from the second signal recording laser 2603 goes into the PBS 2607.

The light emitted from the first signal recording laser 2602 is substantially parallelized by the coupling lens 2605. The light emitted from the first signal recording laser 2602 goes through the coupling lens 2605, and then goes into the PBS 2607. The PBS 2607 combines the S-polarized component of the light emitted from the second signal recording laser 2603 with the P-polarized component of the light emitted from the first signal recording laser 2602 such as to share an optical axis.

The combined light beams go through the collimator 2608 composed of two lenses, then go into the half-mirror 2610, and then are combined with the light emitted from the control light laser 2601 such as to share an optical axis.

The second focus adjustment section 506 can move one lens of the collimator 2608 in the optical path directions (directions 2622).

The light emitted from the control light laser 2601 is substantially parallelized by the coupling lens 2604, then passes the mirror 2609, and then is combined with the other light (emitted from the first and second signal recording lasers 2602, 2603) such as to share an optical axis, by the half-mirror 2610. The combined three light beams pass the mirror 2611, and then are focused respectively on three different points on the same optical axis in the optical recording medium 100 by the objective lens 2612.

The light from the control light laser is separated into a main beam composed of zeroth-order diffraction light and side beams composed of positive and negative first-order diffraction light, by a reflection grating (not shown). The side beams are projected onto boundary portions between the groove 110 and the lands 111; the returned light thereof is used for tracking control. FIG. 26 depicts the main beam solely of the control light laser.

The reflectivity of the half-mirrors 2610 and the plane of polarization of the light incident on the PBS 2607 are selected such that the intensity ratios of the three light beams are obtained.

The light from the semiconductor lasers generally has an elliptical spot shape. After the coupling lenses 2604-2606, means (such as a prism) may be provided for converting the spot shape of the light from the semiconductor lasers 2601-2603 into a substantially circular shape.

The optical pickup apparatus comprises: a first focus adjustment section (505 in FIG. 5) for moving the objective lens 2612 in the optical axis directions (directions indicated by numeral 2621); and a second focus adjustment section (506 in FIG. 5) for moving one lens of the collimator 2608 in the directions indicated by numeral 2622.

When the first focus adjustment section moves the objective lens 2612, the three focuses (imaging points) of the light beams from the lasers 2601-2603 move; in contrast, when the second focus adjustment section moves one lens of the collimator 2608, the two focuses (imaging points) of the light beams (other than the control light) from the lasers 2602 and 2603 move.

The first focus adjustment section automatically adjusts such that the control light (emitted from the control light laser 1501) is focused on the control track 103 (focus control, for example, by astigmatism method or spot size detection method). The tracking control section 507 (FIG. 5) carries out tracking control such as to equalize the amounts of the returned light from the side beams.

The second focus adjustment section moves one lens of the collimator 2622 discretely in the optical path directions (directions 1522), and thereby changes the imaging point difference between the control light (emitted from the control light laser 1501) and the recording and reproduction light (emitted from the first signal recording laser 2602) discretely by the unit of twice a predetermined distance (the pitch between two recording tracks adjacent in the elevation directions, assumed to be a predetermined pitch according to a standard). This permits the focus of the recording and reproduction light to move accurately between the up and down recording layers 202. When the second focus adjustment section moves one lens of the collimator 2608, the imaging point of the light emitted from the first signal recording laser 2602 is in linkage with the imaging point of the light emitted from the second signal recording laser 2603, in a state displaced by a predetermined distance (pitch distance between the two recording tracks adjacent in the elevation directions) above the imaging point of the light emitted from the 2603. Thus, the recording apparatus can record or reproduce a signal simultaneously into or from two recording tracks in the optical recording medium.

In reproduction, the reflected light of the light of the control light laser 2601 and the reflected light of the light of recording and reproduction light (the light of the first and second signal recording lasers 2602, 2603), each light having a wavelength different from each other, are separated using a dichroic filter or the like. The reflected light of the light beams (P-polarized light and S-polarized light) of the first and second signal recording lasers 2602, 2603 is separated using the PBS.

FIG. 27 is a schematic configuration diagram of a control apparatus for an optical recording medium according to Embodiment 13. (Illustrated mainly are blocks for recording. The control system thereof and the like are the same as that in the control apparatus for an optical recording medium according to Embodiment 1 shown in FIG. 5, and hence the description is omitted.) In FIG. 27, like blocks to FIG. 5 are designated by like numerals. The description of the like blocks to FIG. 5 is omitted.

In FIG. 27, numeral 100 indicates an optical disk; numeral 501 indicates a spindle motor; numeral 503 indicates an optical head; numeral 504 indicates a head amplifier; numeral 510 indicates a laser drive section; numeral 511 indicates an encoder; numeral 512 indicates a decoder; and numeral 513 indicates an input and output section.

The encoder 511 comprises an encode section 2701 and a memory 2702. The decoder 512 comprises a decode section 2703 and a memory 2704.

The laser drive section 510 comprises a control light laser drive section 2705, a first signal recording laser drive section 2706, and a second signal recording laser drive section 2707.

The encode section 2701 encodes the signal inputted from the input and output section 513, on a sector basis, and then writes the encoded signal into the memory 2702. The memory 2702 reads out simultaneously two sectors of the written-in encoded signal, and then transmits the two sectors to the first signal recording laser drive section 2706 and the second signal recording laser drive section 2707, respectively. The clock frequency for the encode section 2701 to write the encoded signal into the memory 2702 is set to be twice the clock frequency for the memory 2702 to read out simultaneously two sectors of the written-in encoded signal. As such, the control apparatus for an optical recording medium according to the present embodiment can record or reproduce a signal into or from an optical recording medium substantially at twice the data rate, in comparison with that of Embodiment 1 and the like.

The control light laser drive section 2705 drives the control light laser 2601 at a predetermined light emitting power.

In response to the signal of the even-numbered sector (0, 2, . . . ), the first signal recording laser drive section 2706 supplies an electric current to the first signal recording laser 2602, and thereby records the signal of the even-numbered sector onto the recording track of the recording layer having the even layer identification number (0, 2, . . . , 126). In contrast, in response to the signal of the odd-numbered sector (1, 3, . . . ), the second signal recording laser drive section 2707 supplies an electric current to the second signal recording laser 2603, and thereby records the signal of the odd-numbered sector onto the recording track of the recording layer having the odd layer identification number (1, 3, . . . , 127).

In reproduction, the control light laser and the first and second signal recording lasers 2601-2603 are provided with predetermined reproduction electric currents. The optical head 503 receives the reflected light of the three laser light beams. Using the dichroic filter, the optical head 503 separates the reflected light of the light of the control light laser 2601 from the reflected light of the light of recording and reproduction light (the light of the first and second signal recording lasers 2602, 2603), each light having a wavelength different from each other. Further, the optical head 503 separates the reflected light of the light beams of the first and second signal recording lasers 2602, 2603, using the PBS. The description of the process on the control light is omitted (has been described above).

The reproduction signals from the two recording tracks outputted from the head amplifier 504 (read out with the reflected light beams of the first and second signal recording lasers 2602, 2603, respectively) are simultaneously written into the memory 2704 of the decoder 512. The decode section 2703 reads out the encoded signals from the memory 2703 on a sector basis, then decodes the signals, and thereby outputs the decoded signals via the input and output section 513. The decode section decodes alternately the sector read out with the first signal recording laser 2602 and the sector read out with the second signal recording laser 2603.

The clock frequency for the decode section 2703 to read out the reproduction signal from the memory 2704 is set to be twice the clock frequency for the memory 2704 to write the reproduction signal.

As such, the control apparatus for an optical recording medium according to the present embodiment can record or reproduce a signal into or from an optical recording medium substantially at twice the data rate, in comparison with that of Embodiment 1 and the like.

Further, the first signal recording laser 2602 may record a signal onto a recording track, and at the same time, the second signal recording laser 2603 may reproduce a signal from another recording track.

### Embodiment 14

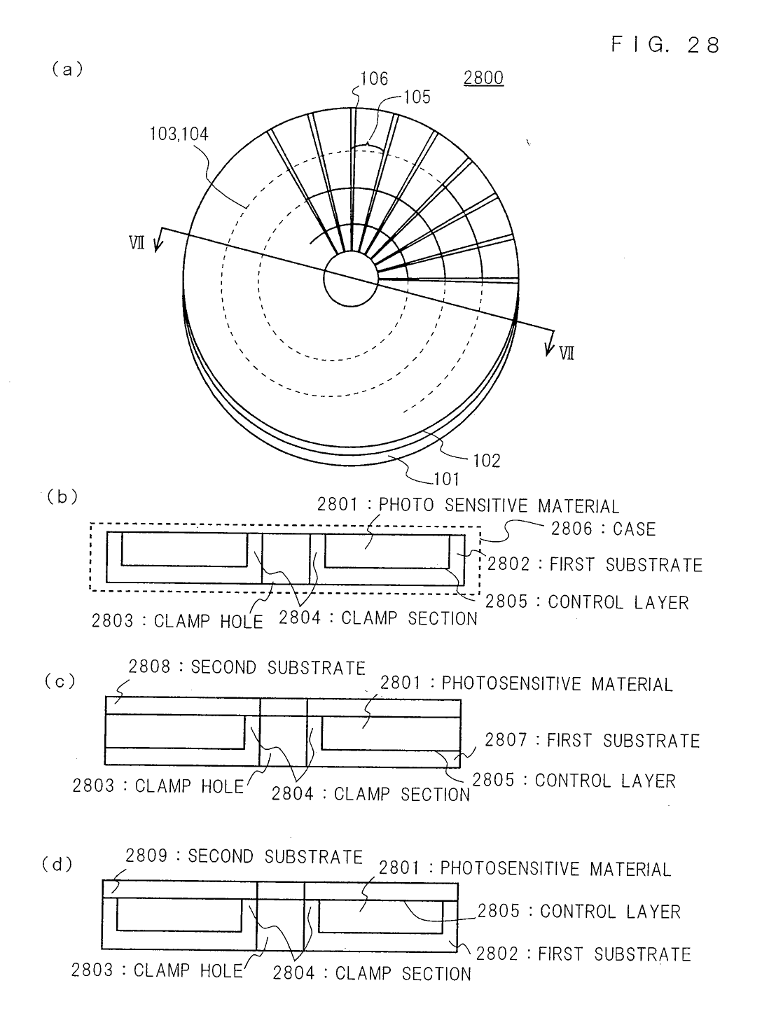

An optical recording medium according to Embodiment 14 of the invention is described below with reference to FIG. 28.

The optical recording medium according to Embodiment 14 is an optical disk for recording information in three dimensions in a photosensitive material composed of a soft material. The “soft material” indicates a material the hardness of which is insufficient if the entirety of the optical recording medium is formed with the material solely. Requirements for the optical recording medium in normal use are that scratches are hard to occur in the surface, that deformation is hard to occur, that wear is hard to occur, and the like. Until these requirements are satisfied, the optical recording medium is not practical.

The photosensitive material of the optical recording medium according to Embodiment 14 is composed of a soft resin containing a photosensitive material, such as photochromic molecules (for example, spirobenzopyran), distributed therein. In the optical recording medium according to Embodiment 14, a predetermined portion is formed with a hard material (a material harder than the photosensitive material and having necessary hardness for practical use), whereby the overall optical recording medium has sufficient hardness for practical use. The optical recording medium also has sufficient rigidity for practical use.

FIG. 28(a) is a schematic plan view (general configuration diagram) of the optical recording medium 2800 according to Embodiment 14; and FIG. 28(b) is a schematic cross sectional view of the optical recording medium, taken along line VII-VII of FIG. 28(a). For the simplicity of illustration, in FIG. 28(b), the optical recording medium is depicted such that the thickness (approximately 1.4 mm) is enlarged in comparison with the radius (approximately 50 mm). (The situation is similar in FIGS. 28(c) and 28(d).)

FIG. 28(a) is the same as FIG. 1(a), and hence the description is omitted. In FIG. 28(b), numeral 2801 indicates a soft photosensitive material; and numeral 2802 indicates a first substrate (harder than the photosensitive material and composed of polyolefin, glass, PMMA, or the like). The optical recording medium 2800 has a clamp hole 2803 in the center. A control layer 2805 is formed on the upper surface the first substrate 2802. The control layer has bee described above in Embodiment 1 in detail.

The control apparatus comprises a turntable having a protrusion in the center. The optical recording medium is placed on the turntable, and the protrusion is engaged with the clamp hole 2803, whereby the optical recording medium 2800 is mounted on the control apparatus. The clamp section 2804 (which is a positioning section for preventing the misalignment of the optical recording medium in the control apparatus, and which comprises the inner periphery of the optical recording medium engaging with the protrusion), the rear surface and the outer periphery of the optical recording medium are formed by the first substrate 2802. The optical recording medium according to Embodiment 14 is used in a state contained in a plastic case 2806. The optical recording medium 2800 is not removed from this case 2806. When the optical recording medium is inserted into the control apparatus, the control apparatus automatically opens the cover of the case 2806 (the structure of the cover is arbitrary), whereby the optical pickup apparatus of the control apparatus records or reproduces information into or from the optical recording medium.

In the optical recording medium according to Embodiment 14, all portions contacting with other materials are composed of the material of the first substrate 2802 having sufficient hardness; accordingly, scratches are hard to occur, deformation is hard to occur, and wear is hard to occur.

FIG. 28(c) is a schematic cross sectional view of another optical recording medium according to the invention, taken along line VII-VII of FIG. 28(a). (The plan view thereof is the same as Embodiment 14 shown in FIG. 28(a).) Like parts to Embodiment 14 are designated by like numerals. The another optical recording medium shown in FIG. 28(c) comprises: a photosensitive material 2801 (composed of the same material as Embodiment 14); a first substrate 2807 (forming the clamp section 2804 and the rear surface of the optical recording medium, and comprising a control layer 2805); and a second substrate 2808 covering the upper surface of the optical recording medium and having sufficient hardness (composed of a material, such as polyolefin, glass, or PMMA, harder than the photosensitive material). This another optical recording medium is used without a case. The method of mounting the another optical recording medium is the same as Embodiment 14.

In the another optical recording medium, all portions contacting with other materials are composed of the material of the first substrate 2807 and the second substrate 2808 having sufficient hardness; accordingly, scratches are hard to occur, deformation is hard to occur, and wear is hard to occur.

FIG. 28(d) is a schematic cross sectional view of further another optical recording medium according to the invention, taken along line VII-VII of FIG. 28(a). (The plan view thereof is the same as Embodiment 14 shown in FIG. 28(a).) The further another optical recording medium shown in FIG. 28(d) comprises: a photosensitive material 2801 (composed of the same material as Embodiment 14); a first substrate 2802 (forming the clamp section 2804, the rear surface and the outer periphery of the optical recording medium); and a second substrate 2809 covering the upper surface of the optical recording medium and having sufficient hardness (composed of a material, such as polyolefin, glass, or PMMA, harder than the photosensitive material; comprising a control layer). This further another optical recording medium is used without a case. The method of mounting the further another optical recording medium is the same as Embodiment 14.

In the another optical recording medium, all portions contacting with other materials are composed of the material of the first substrate 2802 and the second substrate 2809 having sufficient hardness; accordingly, scratches are hard to occur, deformation is hard to occur, and wear is hard to occur.

As described above, the control layer 2805 may be formed on the first substrate (the first substrate or a part thereof forms the rear surface of the optical recording medium) (FIGS. 28(b) and 28(c)), or on the second substrate (the second substrate or a part thereof forms the upper surface of the optical recording medium) (FIG. 28(d)). Whether the outer periphery of the optical recording medium is to be formed with a hard material or not is preferably determined with considering the application thereof and the type of the photosensitive material.

In the above-mentioned embodiments, various signals have been generated using the reproduction signal of the clock pit as the reference. However, the optical recording medium may be provided with no clock pit; then, using the level change in the reproduction signal of the control light at the changing point from the groove to the servo region (or the changing point from the servo region to the groove) of the optical recording medium, various signals may be generated using the changing point as the reference.

Similarly, using the level change in the reproduction signal of the control light at the changing point from the land to the servo region (or the changing point from the servo region to the land) of the optical recording medium, various signals may be generated using the changing point as the reference.

The clock pit may be avoided, whereby a wobble pit may serve as the function of clock pit.

In Embodiments 1-3 and the like, grooves and lands have been provided for tracking control signals. However, a continuous signal pit series may be provided as a control track.

In the optical pickup apparatus and the control apparatus according to Embodiment 1 and the like, tracking control has been carried out by three-beam method; however, push pull method may be used instead.

The position information may be recorded by a zigzag of the groove. For example, the position information can be reproduced on the basis of the output signal of the side beams.

Non-rewritable intrinsic information which is common to the optical recording media replicated from the same master disk (information different from that recorded in the optical recording media replicated from a different master disk) may be recorded on the innermost or outermost control track 103 provided with a groove, an land, or a groove and an land in the optical recording medium. Recorded are, for example, identification information of the optical recording medium and secret information for preventing the illegal copy by a user. Similarly, non-rewritable intrinsic information which is common to the optical recording media replicated from the same master disk may be recorded in the mirror portion, the innermost circumference, or the outermost circumference of the optical recording medium of sample servo scheme.

In the above-mentioned embodiments, the control track and the recording track have been divided into 1280 segments 105 by the servo regions provided radially (in the radial directions of the optical disk). This is an illustration, and hence another configuration may be used. For example, the optical recording medium may have a plurality of zones, whereby the tracks may be divided into a plurality of segments by servo regions provided radially in each zone. Further, segments having the same length may be provided along the control track or the recording track. (Segment boundaries do not align.)

Instead of the distributed address, address information may be recorded in a manner concentrated in a predetermined data recording region.

In the above-mentioned embodiments, position information has been recorded on the control track. However, instead of this or in addition to this, position information and a layer identification signal may be recorded on the recording track.

In the above-mentioned embodiments, an optical disk having a control layer has been illustrated; however, a control layer may be directly formed on the surface of the photosensitive material. In the above-mentioned embodiments, an optical recording medium having a disk shape has been illustrated; however, an optical recording medium having a card shape may be used; in this case, the groove for tracking control may be linear.

The invention advantageously provides an optical recording medium, an optical pickup apparatus and a control apparatus for an optical recording medium which have the changeability and compatibility of media and a large capacity in three dimensions. Even when the optical recording medium is removed from and again mounted on a recording and reproducing apparatus, or alternatively even when the optical recording medium is mounted on another recording and reproducing apparatus, tracking control is carried out again, whereby a recording layer is identified on the basis of the recording layer identification signal; this permits easy identification of the same position in the optical recording medium, and realizes the changeability and compatibility of optical recording media.

The invention advantageously provides a control apparatus for an optical recording medium for recording or reproducing a signal at a high speed.

The invention has been described above in certain detail with reference to a preferred mode; however, the preferred mode and the disclosed embodiments can be modified in detail; further, the combination or the order of components can be changed without departing from the sprit and scope of the invention.

What is claimed is:

1. An optical recording medium comprising:
an optical disk substrate;
a control layer, formed on said optical disk substrate, having a control track provided with a tracking control signal; and
a photosensitive material, formed on said control layer, capable of forming a recording track as a result of a change in an optical property thereof responsive to a specific light beam radiation, the optical property of all the recording tracks on a predetermined circumference of said optical disk substrate having been entirely changed in advance.

2. The optical recording medium according to claim 1, wherein the predetermined circumference is the innermost circumference of said optical disk substrate.

3. The optical recording medium according to claim 1, wherein the predetermined circumference is one circumference of the control track.

4. The optical recording medium according to claim 1, wherein the optical property of all the recording tracks on a predetermined circumference of said optical disk substrate has been entirely changed in advance for the purpose of calibration of the focal position of an optical pickup apparatus.

5. The optical recording medium according to claim 1, wherein said control layer is integrated into said optical disk substrate.
